(19) United States
(12) Patent Application Publication
(10) Pub. No.: US 2023/0042036 A1
(43) Pub. Date: Feb. 9, 2023

(54) MICRONUTRIENT DELIVERY TO GUM POCKET

(71) Applicants: Texas Tech University System, Lubbock, TX (US); 3i Biotechnologies LLC, Lubbock, TX (US)

(72) Inventors: David Syn, Lubbock, TX (US); Harvinder Singh Gill, Lubbock, TX (US); Seth Bose, Lubbock, TX (US); Rohan J. Ingrole, Lubbock, TX (US)

(21) Appl. No.: 17/956,270

(22) Filed: Sep. 29, 2022

Related U.S. Application Data
(63) Continuation-in-part of application No. 17/909,480, filed on Jan. 1, 0001.
(60) Provisional application No. 63/229,784, filed on Aug. 5, 2021.

(51) Int. Cl. A61C 15/04; A23L 33/15; A23L 33/16

(52) U.S. Cl. CPC A61C 15/041; A23L 33/15; A23L 33/16

(57) ABSTRACT

The present invention includes composition and methods of delivering one or more nutrients to a subject comprising: delivering an effective amount of one or more nutrients into a gingival crevice wherein the amount is sufficient to supplement the diet of the subject for the nutrients.

### CROSS-REFERENCE TO RELATED APPLICATIONS

This application claims priority to and is a continuation-in-part of U.S. application Ser. No. 17/909,480, filed Sep. 6, 2022, which is the National Stage of International Application No. PCT/US2022/039536, filed on Aug. 5, 2022 claiming the priority of U.S. Provisional Application Ser. No. 63/229,784, filed Aug. 5, 2021, the entire contents of which are incorporated herein by reference.

### TECHNICAL FIELD OF THE INVENTION

The present invention relates in general to the field of targeting the nutrients, and more particularly, to targeting the junctional epithelium (JE) in the gingival crevice for delivery of nutrients and/or micronutrients.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with immunizations and allergen immunotherapy.

Micronutrient deficiencies in humans prevent healthy development, inhibit health maintenance and cause diseases. Severe forms can cause premature death. Eliminating these deficiencies will promote healthy development, health maintenance, prevent disease and potentially prevent premature death. The general population worldwide would benefit from this simple intervention and subpopulations that are at particularly high risk for micronutrient deficiencies such as the obese population and even more so the obese population that has undergone surgery to treat their obesity would benefit dramatically.

Micronutrients are not produced in the body, except vitamin D, and must be consumed in the diet. It is estimated that over half of children younger than 5 years of age worldwide suffer from vitamin and mineral deficiencies. More than 2 billion people worldwide suffer from micronutrient malnutrition. Iron deficiency is the leading cause of anemia affecting 40% of children under the age of 5 and 30% of pregnant women globally. In the U.S. population, vitamin D deficiency is 8%, however, is likely much higher worldwide. In the U.S. population, micronutrient malnutrition varies by age, gender, or race/ethnicity, however, overall approaches 10% of the population and for certain populations is much higher such as non-Hispanic black (31%), Mexican American (12%) for vitamin D deficiency.

Iron, Zinc, and Iodine are essential in preventing anemia, promoting immune function, resisting diseases such as diarrhea, pneumonia, and malaria, and for promoting healthy cognitive development in infants. Vitamin A is essential for healthy eyesight and proper immune function and prevents blindness and death from infections such as measles and diarrhea. Vitamin D and Calcium are essential for healthy bone mineralization and prevents rickets in children and osteoporosis and osteomalacia in adults.

Micronutrient deficiencies are well documented in the obese population due to factors such as fat sequestration, inflammation-associated malabsorption in the gut, and hyperinsulinemia-associated excretion in the urine. This association worsens with increasing obesity and is highest amongst premenopausal obese females. The problem of micronutrient deficiency is also confounded by the increase in the incidence of morbid obesity and the subsequent increase in frequency of the only known effective treatment for morbid obesity, bariatric surgery. In the U.S., the percentage of the population with class/grade I obesity (bmi 30-34.9) is 20.6%, class II (bmi 35-39.9) is 8.8%, class III (bmi>40) is 6.9%. The number of bariatric procedures performed annually is increasing and 256,00 bariatric procedures were performed in 2019 in the U.S alone. Although bariatric surgery is highly effective in treating morbid obesity and the metabolic comorbidities associated with it and in extending life expectancy and reducing the health-related costs due to obesity, the downside is that it can result in micronutrient deficiencies that can lead to serious health issues and even death if post-surgery vitamin regimens are not adhered to, such as Vitamin B1 or Thiamine deficiency resulting in Wernicke's encephalopathy and potentially permanent neurologic damage and even death. Morbidly obese individuals that have undergone bariatric surgery, are at the highest risk for developing micronutrient deficiencies. The fat-soluble vitamins such as A, D, E, and K as well as water-soluble vitamins such as B (1, 3, 6, 9, 12), Copper, Zinc, Calcium, and Iron have all been documented to be lower in this population after surgery for a variety of complex reasons. Micronutrients obtained from the diet alone after individuals have undergone bariatric surgery are not sufficient in preventing these micronutrient deficiencies. For this reason, it is mandatory that post-bariatric surgery individuals supplement their diets with oral vitamins and minerals in order to prevent these deficiencies. These deficiencies are due to many complex reasons, foremost being that bariatric procedures alter the anatomy of the normal gastrointestinal tract by altering the shape of the stomach and/or by bypassing certain portions of the intestinal tract to varying degrees. These procedures can result in malabsorption to varying degrees, especially of fat, alter pH, reduce total caloric intake, volume of food intake, volume of liquid intake, alter food preferences and reduce levels of certain substances crucial to vitamin absorption such as “intrinsic factor”. The micronutrients most commonly affected by these alterations that have the most significant clinical relevance are Vitamin B1, B12, D, K, A, E, Folate, Iron and Calcium. Because of this, the absorption of oral supplements is also affected and special dosage forms are needed. The current regimen of supplementation can be difficult due to the number, frequency of taking, or taste of these supplements, which can lead to non-compliance. The regimen requires education and counseling and can be difficult, which often results in noncompliance. There is also a commercially available skin patch from PatchMD®. The company offers no scientific evidence of efficacy and the few clinical trials that have been conducted by third party investigators has shown the patch from PatchMD® to be significantly inferior to oral supplementation resulting in significantly higher micronutrient deficiency rates when the patch is used as the sole supplement. Certain vitamins that are particularly important in the post bariatric surgery population such as B12 or B1 are often injected subcutaneously or intramuscularly, for maintenance dosing, either on a weekly or monthly basis, which can be costly and also painful. There are also nasal spray and sublingual applications of vitamin B12 which are effective however are expensive and limited to this vitamin. Lack of proper monitoring of and diagnosis of and timely treatment of some of these micronutrient deficiencies, such as vitamin B1 or thiamine deficiency, has resulted in incidents of severe health issues such as Wernicke's encephalopathy and even death, which has resulted in a significant increase in malpractice litigation. Micronutrient deficiencies that are diagnosed and severe will often be treated with parenteral methods of delivery. This often occurs in patients that are hospitalized. The methods of delivery will either be intravenous, subcutaneous or intramuscular injections. These methods are costly and can be painful and reserved for patients that are already in the hospital setting and require prolonged treatment.

A simpler, more practical method of micronutrient supplementation is needed in order to improve compliance and thus reduce the risk of these deficiencies. Despite these advancements, a need remains for a nutrient-targeting strategy that maximizes the dosing of a nutrient or micronutrient to a subject.

### SUMMARY OF THE INVENTION

As embodied and broadly described herein, an aspect of the present disclosure relates to a method of delivering one or more nutrients to a subject comprising: delivering an effective amount of one or more nutrients into a gingival crevice wherein the amount is sufficient to supplement the diet of the subject for the nutrients. In one aspect, the one or more nutrients are not targeted for delivery to a vestibular mucosa. In another aspect, the one or more nutrients target an epithelium in the gingival crevice, a crevicular epithelium, a junctional epithelium, or combinations thereof. In another aspect, the one or more nutrients are encapsulated to maximize delivery of the one or more nutrients. In another aspect, the method further comprises adding one or more agents that increase permeability of the one or more nutrients into the epithelium of the gingival crevice. In another aspect, between 0.001%-100% of the one or more nutrients is in a depot at a junctional epithelium (JE) of the gingival crevice. In another aspect, the one or more nutrients are provided repeatedly to a junctional epithelium of the gingival crevice. In another aspect, the delivery of one or more nutrients to a junctional epithelium is after consumption of a food or drink, or brushing of teeth. In another aspect, the one or more nutrients is applied once or more than once with a frequency on a daily or weekly or monthly basis, such as 1, 2, 3, 4, 5, or 6 times daily or 1, 2, 3, 4, 5, 6, or 7 times weekly, or 1, 2, 3, or 4 times monthly. In another aspect, the one or more nutrients provide 10%, 20%, 30%, 40%, 50%, 60%, 70%, 80%, 90% or 100% of the daily dietary requirement by flossing 1, 2 or 3 times a day. In another aspect, the delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks liquid, or brushing of teeth. In another aspect, the delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks liquid, or brushing of teeth. In another aspect, the amount of the one or more nutrients delivered to a crevicular epithelium, a junctional epithelium, or combinations thereof from picograms to milligrams. In another aspect, the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K.

As embodied and broadly described herein, an aspect of the present disclosure relates to a nutrient delivery system comprising an effective amount of one or more nutrients on a delivery device that targets a junctional epithelium at a gingival crevice, wherein an amount of the one or more nutrients is a nutritionally effective amount. In one aspect, the one or more nutrients are not delivered to a vestibular mucosa. In another aspect, the delivery device comprises a cross-sectional shape that maximizes delivery of the one or more nutrients into the gingival crevice. In another aspect, the nutrient delivery system further comprises one or more agents that increase a permeability of the one or more nutrients into an epithelium in the gingival crevice, a crevicular epithelium, a junctional epithelium, or combinations thereof. In another aspect, the between 0.001%-100% of the one or more nutrients is in a depot at a crevicular epithelium, a junctional epithelium, or combinations thereof, of the gingival crevice. In another aspect, the nutrient delivery system further comprises one or more pharmaceutically acceptable carriers, excipients, diluents, buffers, or salts. In another aspect, the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K.

As embodied and broadly described herein, an aspect of the present disclosure relates to a method of making a floss that comprises a pre-determined amount of one or more nutrients comprising: providing a floss; and depositing on the floss one or more deposits of the one or more nutrients in a pharmacologically acceptable carrier, wherein each deposit has a known, pre-determined amount of the one or more nutrients. In one aspect, each adjacent deposit comprises the same one or more nutrients or different one or more nutrients, or each adjacent deposit comprises the same one or more nutrients in a different concentration; or wherein each adjacent deposit comprises different one or more nutrients in a different concentration; or each adjacent deposit is placed on a different plane from the adjacent deposit; or each adjacent deposit is placed on an opposite side of the floss from the deposit; or adjacent deposits each comprise different one or more nutrients from a prior adjacent deposit. In another aspect, each adjacent deposit comprises different one or more nutrients with different solvent requirements selected from one or more nutrients with solubility in water-based solvent/s and the other one or more nutrients with solubility in organic solvent/s. In another aspect, the two or more nutrients are deposited on top of one another in form of deposit with the same or different distance/lengths. In another aspect, the one or more nutrients with different solvent requirements are deposited on opposite sides over the same or different distance/lengths. In another aspect, the one or more nutrients with same solvent requirement are deposited on top of one another with the same or different distance/lengths. In another aspect, the e one or more nutrients with different solvent requirement are deposited on opposite side with the same or different distance/lengths. In another aspect, the floss is solid, frayed, comprises multiple strands, has been treated to be adhesive, has been treated to adhere to the pharmacologically acceptable carrier, or has been treated to adhere to the active agent. In another aspect, each adjacent deposit comprises a dye or indicia that distinguishes between adjacent drops or patches. In another aspect, the floss is not dipped into the one or more nutrients, the pharmacologically acceptable carrier, or both. In another aspect, the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K. In another aspect, the floss has a thickness less than 5 mm, preferably less than 3 mm, and preferably less than 1 mm, or preferably 35 to 175 microns. In another aspect, the floss comprises natural or synthetic polymers, organic materials, metals, inorganic materials or combinations thereof. In another aspect, the floss comprises a mucoadhesive layer or a hydrophobic layer or a hydrophilic layer or a combination. In another aspect, the floss comprises a microporous structure allowing diffusion of the one or more nutrients to gingival crevice. In another aspect, the floss delivers the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks liquid, or brushing of teeth. In another aspect, the floss delivers the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks liquid, or brushing of teeth. In another aspect, a viscosity of the deposit is 0.01 centipoise (cp), 1 cp, 10 cp, 100 cp, 1000 cp, 10000 cp, 100000 cp, 200000 cp, 300000 cp, 500000 cp, 1000000, or 100000000 cp.

As embodied and broadly described herein, an aspect of the present disclosure relates to a floss that comprises a pre-determined amount of one or more nutrients comprising: a floss; and a deposit on the floss one or more depots of the one or more nutrients in a pharmacologically acceptable carrier, wherein each droplet or patch has a known, pre-determined amount of the active agent. In one aspect, each adjacent deposit comprises the same one or more nutrients or different one or more nutrients, or each adjacent deposit comprises the same one or more nutrients in a different concentration; or wherein each adjacent deposit comprises different one or more nutrients in a different concentration; or each adjacent deposit is placed one a different plane from the adjacent deposit; or each adjacent deposit is placed on an opposite side of the floss from the adjacent deposit; or adjacent deposit each comprise different one or more nutrients from a prior adjacent deposit. In another aspect, each adjacent deposit comprises of one or more nutrients with different solvent requirements, selected from one or more nutrients with solubility in water-based solvent/s and the one or more nutrients with solubility in organic solvent/s. In another aspect, the one or more nutrients are deposited on top of one another in form of drop or patch with the same or different distance/lengths. In another aspect, the one or more nutrients with different solvent requirements are deposited on opposite sides over the same or different distance/lengths. In another aspect, the one or more nutrients with same solvent requirement are deposited on top of one another with the same or different distance/lengths. In another aspect, the one or more nutrients with different solvent requirement are deposited on opposite side with the same or different distance/lengths. In another aspect, the floss is solid, frayed, comprises multiple strands, has been treated to be adhesive, has been treated to adhere to the pharmacologically acceptable carrier, or has been treated to adhere to the active agent. In another aspect, each adjacent drop or patch comprises a dye or indicia that distinguishes between adjacent deposit. In another aspect, the floss is not dipped into the one or more nutrients, the pharmacologically acceptable carrier, or both. In another aspect, the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K. In another aspect, the floss has a thickness less than 5 mm, preferably less than 3 mm, preferably less than 1 mm, or preferably 35 to 175 microns. In another aspect, the floss comprises natural or synthetic polymers, organic materials, metals, inorganic materials or combinations thereof. In another aspect, the floss comprises a mucoadhesive layer or a hydrophobic layer or a hydrophilic layer or a combination. In another aspect, the floss comprises a microporous structure allowing diffusion of antigen to gingival crevice. In another aspect, the one or more nutrients are delivered to the junctional epithelium in a range from picograms to milligrams. In another aspect, the one or more nutrients provide 10%, 20%, 30%, 40%, 50%, 60%, 70%, 80%, 90% or 100% of the daily dietary requirement by flossing 1, 2 or 3 times a day. In another aspect, the delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks liquid, or brushing of teeth. In another aspect, the delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks liquid, or brushing of teeth. In another aspect, the viscosity of the deposit is 0.01 centipoise (cp), 1 cp, 10 cp, 100 cp, 1000 cp, 10000 cp, 100000 cp, 200000 cp, 300000 cp, 500000 cp, 1000000, or 100000000 cp.

### BRIEF DESCRIPTION OF THE DRAWINGS

For a more complete understanding of the features and advantages of the present invention, reference is now made to the detailed description of the invention along with the accompanying figures and in which:

FIGS. 1A to 1F show the gingival crevice and junctional epithelium: (FIG. 1A) Human mouth. (FIG. 1B) Structure of gingival crevice and junctional epithelium (JE). (FIG. 1C) Delivery of active agent to junctional epithelium in gingival crevice and the diffusion of active agent in junctional epithelium and adjacent tissue over time, (FIG. 1D) delivery of antigen molecule coated on floss and effect of flossing on mouse gum tissue, and (FIG. 1E) diffusion of ovalbumin (Ova) conjugated to rhodamine in gum tissue (ex-vivo). Flossing is performed, on each of the incisor tooth, by placing antigen deposited floss around the tooth and flossing for approximately ten to fifteen times so that the coated antigen gets deposited on the gum line. (FIG. 1F) Delivery efficiency of floss coated with fluorescein isothiocyanate (FITC) conjugated ovalbumin (Ova).

FIGS. 2A to 2G show floss-mediated vaccine delivery and characterization of immune response. (FIG. 2A)(1) Coated floss stereomicrograph and FIG. 2A(2) flossing procedure in mice. (FIG. 2B) Vaccination schedule: Balb/c mice (n=5) were vaccinated by flossing antigen (Ovalbumin (Ova), a model antigen) deposited floss on their gums. Floss included a deposit of 25 μg Ova+/−25 μg CpG (single-stranded oligodeoxynucleotide adjuvant) and mice were vaccinated weekly, up to 4 weeks total. Mice treated with floss without any coating were treated as control. Systemic immune response: Mice were bled at day 28 and 56, and anti-Ova antibody response (at either 1:12500 or 1:2500 dilution) in serum was analyzed through enzyme-linked immunosorbent assay (ELISA). FIG. 2(C)(1)-(3) Anti-Ova antibody response at day 56-FIG. 2(C)(1) IgG, FIG. 2(C)(2) IgG1 and FIG. 2(C)(3) IgG2a. Individual mouse serum was used in analysis. FIG. 2(D)(1)-(3) shows the memory immune response: Vaccinated mice were euthanized, and bone marrow cells were collected. Cells were cultured in triplicates in a concentration of 1×10⁶ cells per well with RPMI medium supplemented with 10% fetal bovine serum and penicillin-streptomycin antibiotics. Supernatant of cultured cells were collected post 96 h and anti-Ova responses were analyzed. FIG. 2(D)(1)-(3) Anti-Ova antibody response in bone marrow cells—FIG. 2(D)(1) IgG,

FIG. 2(D)(2) IgG1, FIG. 2(D)(3) IgG2a. This result suggests that the response is not just local and systemic but was able to induce a memory response to better prepare individual for future exposure to same antigen (Ag). FIG. 2(E)(1)-(4) show the mucosal immune response. At day 56, fecal matter, nasal wash and lung lavage were collected from the vaccinated and mice that were treated with floss only. Anti-Ova FIG. 2(E)(1) IgG in fecal matter (1:5 dilution), FIG. 2(E)(2) IgA in fecal matter (1:5 dilution), FIG. 2(E)(3) IgG in nasal wash (undiluted), and FIG. 2(E)(4) IgG lung lavage (undiluted). FIG. 2(F)(1)-(2) No significant amount of IgE was detected either (1) in the serum or (2) in the bone marrow of the mice vaccinated through floss indicating that the target site of JE does not sensitize the individual against the delivered Ag. FIG. 2(G) Vaccinated mice were euthanized and splenocyte cells were collected. Cells were cultured, re-stimulated by Ova (200 m/ml) in triplicates in a concentration of 1×10⁶ cells per well with RPMI medium supplemented with 10% fetal bovine serum and penicillin-streptomycin antibiotics. Supernatant of cultured cells were collected post 96 h and cytokine levels were analysed. FIG. 2(G) shows cytokine levels in spleenocyte culture, FIG. 2(G)(1) IFN-gamma, and FIG. 2(G)(2) IL-4. Data represented as mean±SD. One-way ANOVA test was used to compare between the groups at different serum dilutions. *p<0.05, **p<0.01, ***p<0.001, and ****p<0.0001.

FIGS. 3A to 3C show a floss for influenza vaccination. FIG. 3(A) Vaccination schedule: Balb/c mice (n=10) were vaccinated either with 10 μg or 25 μg of Inactivated (Inac.) virus coated on a floss for a total of three times—once on each of day 0, 14 and 28. At day 56, mice were bled and anti-Inac. virus immune response (at either 1:800 or 1:50 dilution) was analyzed through ELISA. FIG. 3(B)(1)-(3) Anti-Inac. virus FIG. 3(B)(1) IgG, FIG. 3(B)(2) IgG1, FIG. 3(B)(3) IgG2a antibody response in serum at day 56. Virus challenge: At d56, mice were challenged with 3×LD₅₀ (lethal dose 50%) of A/PR/8/34 (H1N1) influenza virus. Individual mice samples were used in analysis. Data represented as mean±SD. One-way ANOVA test was used to compare between the groups. *p<0.05, **p<0.01, ***p<0.001, and ****p<0.0001. FIG. 3(C)(1)-(2) Mice were observed every day for change in the body weight and severity of infection. FIG. 3(C)(1) Percent change in body weight, FIG. 3(C)(2) percent survival rate of vaccinated mice after infection. n=5 mice in each group.

FIGS. 4A to 4D show floss-mediated delivery of M2e-AuNP+CpG (MAC), a vaccine formulation consisting of a peptide (M2e) conjugated to gold nanoparticles (AuNP's) further supplemented with an adjuvant (CpG), vaccine and characterization of immune response. FIG. 4(A)(1) Stereomicrograph of floss coated with M2e-AuNP+CpG containing 56 μg of AuNP's, 8.1 μg of M2e and 20 μg of CpG (1× dose) and FIG. 4(A)(2) flossing procedure in mice. FIG. 4(B) Vaccination schedule: Balb/c mice (n=10) were vaccinated by either flossing vaccine formulation [M2e-AuNP+CpG (MAC)] coated floss on their gums or by placing the vaccine formulation [M2e-AuNP+CpG (MAC)] under tongue [sublingual immunotherapy (SLIT)]. Vaccine formulation (MAC), either coated on floss or delivered through SLIT, consisted of 56 μg of AuNP's, 8.1 μg of M2e and 20 μg of CpG (single-stranded oligodeoxynucleotide adjuvant) and mice were vaccinated on day 0 and day 21. Naïve mice that received no treatment were treated as control. Systemic immune response: Mice were bled at day 21 and 42, and anti-M2e antibody response (at 1:6400 dilution) in serum was analyzed through enzyme-linked immunosorbent assay (ELISA). FIG. 4C(1)-(3) Anti-M2e antibody response in serum at day 42—FIG. 4C(1) IgG, FIG. 4C(2) IgG1 and FIG. 4C(3) IgG2a. Individual mouse serum was used in analysis. Data represented as mean±SD. One-way ANOVA test was used to compare between the groups. *p<0.05, **p<0.01, ***p<0.001, and ****p<0.0001. Virus challenge. (FIG. 4D(1)-(2)) At day 43, mice were challenged with 3×LD₅₀ (lethal dose 50%) of A/California/07/2009 H1N1 virus. Mice were observed every day for change in the body weight and severity of infection. FIG. 4D(1) Percent change in body weight, FIG. 4D(2) percent survival rate of vaccinated mice after infection. n=5 mice in each group.

FIGS. 5A to 5E show floss-mediated vaccine delivery and characterization of immune response. (FIG. 5A) Vaccination schedule: Balb/c mice (n=5) were vaccinated by flossing antigen (Peanut extract (PE)) deposited floss on their gums. Floss was deposited with 25 μg PE+/−25 μg CpG (single-stranded oligodeoxynucleotide adjuvant) and mice were vaccinated weekly, up to 4 weeks total. Mice treated with floss without any coating or deposits were treated as control. Systemic immune response: Mice were bled at day 28 and 56, and anti-PE antibody response (at 1:12500 dilution) in serum was analyzed through enzyme-linked immunosorbent assay (ELISA). FIG. 5B(1)-(3) Anti-PE antibody response in serum at day 56—FIG. 5B(1) IgG, FIG. 5B(2) IgG1 and FIG. 5B(3) IgG2a. Individual mouse serum was used in analysis. (FIG. 5C(1)-(3)) Memory Immune response: Vaccinated mice were euthanized, and bone marrow cells were collected. Cells were cultured in triplicates in a concentration of 1×10⁶ cells per well with RPMI medium supplemented with 10% fetal bovine serum and penicillin-streptomycin antibiotics. Supernatant of cultured cells were collected post 96 h and anti-PE responses were analyzed. Anti-PE FIG. 5C(1) IgG, FIG. 5C(2) IgG1, FIG. 5C(3) IgG2a. This result suggests that the response is not just local and systemic but was able to induce a memory response to better prepare individual for future exposure to same antigen (Ag). (FIG. 5D) Mucosal immune response. At day 56, fecal matter, nasal wash and lung lavage were collected from the vaccinated and naïve mice. Anti-PE FIG. 5D(1) IgG in fecal matter (1:5 dilution), FIG. 5D(2) IgA in fecal matter (1:5 dilution), FIG. 5D(3) IgG in nasal wash (undiluted), and FIG. 5D(4) IgG lung lavage (undiluted). (FIG. 5E(1)-(2)) No significant amount of IgE was detected either FIG. 5E(1) in the serum or FIG. 5E(2) in the bone marrow of the mice vaccinated through floss indicating that the target site, junctional epithelium, does not sensitize the individual against the delivered Ag. (Data represented as mean±SD. One-way ANOVA test was used to compare between the groups at different serum dilutions. *p<0.05, **p<0.01, ***p<0.001, and ****p<0.0001.

FIGS. 6A to 6D show a peanut allergen immunotherapy schedule. (FIG. 6A) Immunotherapeutic schedule: Balb/c mice (n=5) were sensitized through oral route [1 mg peanut extract (PE)+15 μg cholera toxin (CT)], given at intervals of a week for five consecutive weeks. Mice were then vaccinated by flossing antigen-coated floss. Floss was coated with 5 μg PE+/−5 μg CpG (single-stranded oligodeoxynucleotide adjuvant) and mice were vaccinated three times per week, up to 3 weeks total. Sensitized mice that did not receive any treatment were kept as control (untreated). Mice were bled at day 10 post-vaccination (PV). Mice were challenged eight weeks post-vaccination with PE allergen (500 μg) through intraperitoneal route (IP), were then euthanized and different tissues were collected. (FIG. 6B(1)-(3)) Anti-PE antibodies in serum (at 1:12500 dilution) were confirmed through enzyme-linked immunosorbent assay (ELISA). Anti-PE FIG. 6B(1) IgG, FIG. 6B(2) IgG1 and FIG. 6B(3) IgG2a antibody response at day 10 post-vaccination. Individual mouse serum was used in analysis. Data represented as mean±SD. One-way ANOVA test was used to compare between the groups at different serum dilutions. *p<0.05, **p<0.01, ***p<0.001, ****p<0.0001.and ns: not significant. PE induced anaphylaxis. (FIG. 6C) (1) Plasma MCPT-1 levels post IP challenge with PE. Histological analysis of intestinal tissue. (FIG. 6D) Eight weeks post-vaccination, mice were challenged with PE allergen (500 μg) through intraperitoneal route. Mice were then euthanized, and small intestine was collected from proximal, middle and distal ends, fixed, dehydrated and embedded in paraffin wax for cutting. Tissue sections were stained with hematoxylin and eosin (H&E) stain and sectioned for histology. FIG. 6D(1) Number of eosinophils counted in respective sections from mice of different treatment groups. FIG. 6D(2) Brightfield image of H&E stained intestine with arrows pointing to eosinophil infiltration. Individual mouse sample was used in analysis. Data represented as mean±SD. One-way ANOVA was used to compare between the groups. *p<0.05, **p<0.01, ***p<0.001 and ns: not significant.

FIGS. 7A to 7D show airway allergen immunotherapy. (FIG. 7A) Immunotherapeutic schedule: Balb/c mice (n=5) were sensitized through two intraperitoneal (IP) injection (25 μg Ova+2 mg of alum (an adjuvant)), given at interval of a week. Ten days post sensitization (PS), mice were challenged with Ova (50 μg) through intranasal route (IN) for three consecutive days to develop airway inflammation. Mice were then vaccinated by flossing with floss onto which antigen was deposited. Floss was coated with 25 μg Ova+/−25 μg CpG (single-stranded oligodeoxynucleotide adjuvant) and mice were vaccinated three times per week, up to 3 weeks total. Sensitized mice that did not receive any treatment were kept as control (untreated). Mice were bled at day 10 post-vaccination. Mice were challenged on day 28 post-vaccination with Ova allergen (50 μg) through intranasal route (IN) for three consecutive days, were then euthanized and different tissues were collected Systemic immune response: (FIG. 7B(1)-(4)) Anti-Ova FIG. 7B(1) IgG, FIG. 7B(2) IgG1, FIG. 7B(3) IgG2a and FIG. 7B(4) IgE antibody response in serum (at either 1:12500 or 1:500 or 1:20 dilution) at day 10 post-vaccination analyzed through enzyme-linked immunosorbent assay (ELISA). (FIG. 7C) Lung lavage analysis post-challenge. Mice were then euthanized, and mucosal secretion of lung lavage was collected. Cell count of FIG. 7C(1) eosinophils and FIG. 7C(2) neutrophils in lung lavage-cells were stained with diff-stain kit and counted by observing cells under confocal microscope. Histological analysis of lungs: (FIG. 7D) Mice were then euthanized, and lungs were harvested, fixed, cleaned and sectioned for histology. Tissue sections were stained with either periodic acid-Schiff (PAS) to stain for mucus deposition or trichrome blue (TCB) to stain for collagen deposition. Representative brightfield image of PAS stained lung (top panel) and TCB stained lung (bottom panel). Arrows in the top panel point to mucus deposition, and to collagen deposition in the bottom panel.

FIG. 8 shows the deposition capabilities, deposition of floss with peptide, nanoparticles, protein, oligonucleotide, microparticles, in different patterns of deposition either as a single region of deposition with a short length or a longer length, or multiple discrete regions of deposition, and only on one side of the floss.

FIG. 9 shows the deposition capabilities, of depositing water soluble and water insoluble materials including pollen grain microparticles.

FIG. 10 shows the deposition capabilities, and different deposition patterns with two different compounds as example. One formulation was ovalbumin (protein) conjugated to NHS-Rhodamine (fluorescent reagent) in water—called as ‘A’, and second was M2e peptide conjugated to gold nanoparticles and CpG (single stranded DNA) in water—called as ‘B’.

FIG. 11 shows the deposition capabilities of multiple materials, shown here are four different food colors (blue, green, yellow, red) deposited as four distinct portions.

FIG. 12 shows the coating capabilities for coating two sides of floss with different formulations.

FIG. 13 shows an example of an automated coating station to coat floss.

FIG. 14 shows two examples of the design of the flosser system.

FIG. 15 shows a floss coated with vitamins B1, B12 and D.

FIG. 16 shows passing of floss in teeth.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention seeks to address micronutrient deficiencies in the general population that are very prevalent and are occurring worldwide and has its roots in complex socioeconomic issues. Micronutrient deficiencies in the bariatric surgery population are also very prevalent and the mainstay for prevention of such currently is oral supplementation. The regimen requires education and counseling and can be difficult, which often results in non-compliance. There is also a commercially available skin patch from PatchMD®. The company offers no scientific evidence of efficacy and the few clinical trials that have been conducted by third-party investigators has shown the patch from PatchMD® to be significantly inferior to oral supplementation resulting in significantly higher micronutrient deficiency rates when the patch is used as the sole supplement. Certain vitamins that are particularly important in the post-bariatric surgery population such as B12 or B1 are often injected subcutaneously or intramuscularly, for maintenance dosing, either on a weekly or monthly basis, which can be costly and also painful. There are also nasal spray and sublingual applications of vitamin B12 which are effective but are expensive and limited to this vitamin.

Micronutrient deficiencies that are diagnosed and severe will often be treated with parenteral methods of delivery. This often occurs in patients that are hospitalized. The methods of delivery will either be intravenous, subcutaneous or intramuscular injections. These methods are costly and can be painful and reserved for patients that are already in the hospital setting and require prolonged treatment.

The present invention uses floss, and particularly, floss onto which nutrients and/or micronutrients have been deposited to address the problem of nutrient/micronutrient deficiencies. In the general population, using coated floss to deliver micronutrients may increase supplementation of micronutrients as some individuals do not like taking pills. This is particularly effective, as is shown herein, to deliver in a very efficient and effective manner, large amounts of nutrients/micronutrients that become immediately available using a daily routine.

In the bariatric surgery population where adherence to vitamin/mineral supplementation regimens after surgery is critical in preventing severe disease and possible death, any method that makes compliance to such regimens easier would significantly reduce morbidity and mortality. Simply passing the coated floss in the gum pocket a few times once a day would be preferable to most individuals vs swallowing multiple tablets or capsules multiple times a day.

To date, no one has described an effective method of coating floss with micronutrients and then delivering that coating to the gum pocket by flossing and then demonstrating elevated levels of these micronutrients in the blood after delivery.

Delivery of the micronutrient into the gum space allows for direct uptake of the micronutrient into the circulatory system without having to inject the micronutrient into the skin or muscle or vein. The application is easy for the individual and there is no pain as is associated with injection. The cost is significantly less as it does not require a visit to a healthcare provider or require special equipment. By allowing for direct uptake into the circulatory system the problems specific to the uptake in the intestinal tract associated with obesity are mitigated. Much smaller doses than the recommended daily allowance will be required as there is no bioavailability issues associated with gut uptake and there is potentially no first pass effect (loss of bioavailability due to first passing through liver).

The oral cavity mucosa in this present invention, contrary to the dogma that simply placing molecules on a mucosal surface does not lead to efficient immune modulation, it is demonstrated that in fact if material is placed on top of the junctional epithelium, a strong immune modulatory response can be achieved. No additional approaches are required to weaken or disrupt the mucosal barrier at the junctional epithelium, simply placing small molecules such as deoxyribonucleic acid (DNA), or large molecules such as proteins, and even nanoparticles and viruses on the junctional epithelium can result in strong immune responses. In fact, the junctional epithelium is rich in lymphatic vessels.

The present invention is directed to administering antigens and allergens through the junctional epithelium in the gingival crevice in order to access strong systemic and mucosal immune responses. Because the junctional epithelium is only 2 mm long and the gingival crevice is 1-2 mm deep, the inventors deposited onto dental floss an antigen and/or an allergen for targeted deposition into the gingival crevice for uptake through the junctional epithelium. While the inventors used a floss to target the junctional epithelium, other approaches that can target the junctional epithelium could be used. For example, a thin flat surface similar in dimensions to the gingival crevice could be used. This flat surface could either be coated with the material of interest to cause immunomodulation, or the material could be encapsulated in the flat surface. The inventors show, using mouse models, that floss can be coated with the antigen/allergen solution, show that the mice teeth can be flossed, and show that this method is as an effective form of antigen/allergen delivery. This new approach serves as a non-invasive, painless, and easy way to administer allergens and antigens for immune modulation. In the case of allergies, the immunization of the present invention serves to dampen the allergic immune response and/or induce a protective immune response against allergen/s. Conversely, the present invention can also be used to trigger an immune response against infectious and other agents.

The present invention can be used with dental floss that is well known in the art. For example, dental floss may be produced as a nylon dental floss in which a nylon is polymerized into a polymer that is formed, pumped, or extruded to form monofilaments or a multitude of filaments. The polymer is allowed to harden, and the monofilaments or a multitude of filaments is combined to form a strand or strands of dental floss. Dental floss may be produced from polytetrafluoroethylene (PTFE or TEFLON®), polypropylene, polyethylene, styrene butadyene copolymers, of combinations thereof. Once formed, the polymer can be melted and extruded into thin strands. See e.g., U.S. Pat. No. 6,270,890, relevant portions incorporated herein by reference.

In one non-limiting example, nylon or PTFE is mixed with a basic amino acid (or a salt thereof), and formed or extruded to form one or more filaments. In the case of multiple filaments, these are generally twisted to form the dental floss. Alternatively, a single ribbon of floss, such as PTFE, can be formed. Often, the dental floss will have a denier of about 450 to about 1350, and in other examples, a floss dernier is from about 100 to about 900.

The dental floss is then deposited with the immunogen(s) and/or allergen(s) and/or antigen(s) of the present invention, as will be known to the skilled artisan. For example, the dental floss is treated in a bath comprising the antigen and/or allergen. The bath may include one or more waxes that adhere to the floss, and thereby cause the antigen and/or allergen to adhere to the floss. In one example, a dental floss comprising a nylon or a PTFE fiber is coated with the antigen and/or allergen. A wax or polymer, e.g., such as polyvinyl alcohol, polyvinyl acetate, can be used to coat the antigen and/or allergen in, or, or about the dental floss. See e.g., U.S. Pat. No. 6,289,904, relevant portions incorporated herein by reference.

For a filamentous dental floss, the antigen and/or allergen can be embedded into the bundle of thin filaments, e.g., nylon filaments, prior to the bundles being formed, while the bundles are formed, or even after they are formed. The bundles may then also be, optionally, coated with a wax or polymer. The number of filaments can be from about 2 to about 500, e.g., from about 2 to about 250, depending on the denier of the dental floss filaments. The dental floss filaments are often twisted with about 1 to 5 twists per inch to form the floss. The twisting provides integrity to the dental floss when placed on a spool and/or during subsequent handling. For immunization, the dental floss filaments will spread out and splay against tooth surfaces at the junctional epithelium of the gingiva, thereby delivering the antigen and/or allergen immunization. The floss may also be formed of interlocking fibers. The dental floss product will preferably of a thickness that allows it to fit not only between the teeth, but to reach the junctional epithelium of the gingiva. Where multiple filaments are used, the coating may be applied before and/or after twisting and generally after application of the antigen and/or allergen. Other additives may be applied to the dental floss to preserve the antigen and/or allergen or to help in the coating process or to achieve controlled release of the antigen and/or allergen.

In addition, a flavor can be applied as a liquid or a solid to the dental floss. Flavors can be spray dried in liquid or solid form. When flavor is applied as a liquid, the floss is generally dried prior to being wound onto a spool. The drying can be air drying or drying until heat, after which the floss is wound onto a spool.

As used herein, the terms “deposit,” “depot”, “deposition” refer to the placing in the form of one or more deposits of the active agent that are separated by a space from adjacent deposit(s) onto a floss.

As used herein, the term “nutrients” and “micronutrients” are used interchangeably, and generally refer to any substance that provides nourishment essential for growth and maintenance of life, including but not limited to, one or more of iron, phosphorous, zinc, thiamine, riboflavin, niacin, vitamin B6, folate, vitamin, B12, pantothenic acid, biotin, boron, choline, chromium, copper, manganese, selenium, molybdenum, iodine, coenzyme Q10 (CoQ10), vitamin A, calcium, potassium, magnesium, vitamin E, vitamin C, a carotenoid, vitamin D, or vitamin K. Other examples of nutrients are proteins, amino acids, lipids, carbohydrates, nucleic acids or their physical or chemical combinations. These can be as pure substances or mixtures or extracts from natural sources.

As used herein, the term “pharmaceutically acceptable carrier” refers to a carrier that does not cause an untoward effect in subjects (e.g., human being/s and pets (such as dog, cat, cows, pigs or other domesticated animals or even non-domesticated animals) to whom it is administered. Suitable pharmaceutically acceptable carriers include, for example, one or more of water, saline, phosphate buffered saline, dextrose, glycerol, ethanol, dimethyl sulfoxide, or the like and combinations thereof. In addition, if desired, the immunization/vaccine can contain minor amounts of auxiliary substances such as wetting or emulsifying agents, pH buffering agents, and/or adjuvants which enhance the effectiveness of the vaccine.

As used herein, the term “subject” refers to human being/s, pets (such as dog, cat, cows, sheep, goats, horses, rabbits, or pigs) or other domesticated animals, or non-domesticated animals such as deer, buffalo, or wild horses.

The junctional epithelium is located at the bottom of the gingival crevice, which is 1-2 mm deep in healthy gums. Furthermore, the apical tissue of the gingival cavity tightly hugs the teeth, allowing only thin instruments measuring less than 1 mm and preferably less than 500 μm to enter the cavity Thus, administration of material into the gingival crevice is not trivial. To overcome this challenge, the present invention uses an antigen and/or allergen deposited onto dental floss. The dental floss is used by millions of people daily to clean their gingival crevices, and this invention describes that it can be coated with the antigen/allergen for targeted deposition into the gingival crevice for uptake through the junctional epithelium. Dental floss offers additional benefits of being non-invasive, painless, and possible self-administration in the comfort of home. The dental floss should be taken as a non-limiting example of a system with the final goal of delivering material to the junctional epithelium. Other approaches based on the principle of enabling and allowing devices to enter the gingival crevice to help target the junctional epithelium such as tapes, films, strips, strings, threads, sutures, gels, hydrogels, polymers, viscous materials, particles or combinations thereof are included in this invention. These systems and devices maybe inserted into the gingival crevice, but may also be placed at the apical aspect of the gingival crevice rather than in to the crevice, and the molecule(s) of interest may then diffuse from the systems and devices into the gingival crevice and ultimately to junctional epithelium for permeation into the tissues. These systems that are placed on the apical side of the gingival crevice maybe designed such that they maximize diffusion of molecules into the gingival crevice, but minimize their loss outward and into the general oral cavity. In one such approach the delivery system can be coated with an impermeable layer on the side that faces opposite to the gingival crevice.

To deposit the floss, the inventors developed a simple manual coating process of applying the material on the floss using a pipette. They selected Oral-B® Glide Pro-Health Original Floss from amongst five different flosses after preliminary coating feasibility studies. Using this method, the inventors were able to coat different molecules on the floss including proteins, small molecules (such as nutrients and/or micronutrients), peptides, nanoparticles, single-stranded DNA oligonucleotide and influenza virus. Next, the inventors established the feasibility of flossing teeth of mice. The inventors chose to floss the lower front incisor teeth due to ease of accessibility. Flossing was done by keeping the mouse under anesthesia. The figures show the incisors before, during and after flossing. Imaging under a fluorescent stereomicroscope confirmed that the coated fluorescent ovalbumin (Ova) gains entrance through junctional epithelium and into the gingival tissue in under 30 min. The inventors determined the fraction of Ova delivered into gingival crevice by quantifying Ova coated on floss (M1) and Ova left on floss after flossing (M2). For n=4 mice, the delivery efficiency ([M1−M2]/M1×100) was about 75%.

Immune response generated when antigen or allergen is administered to the junctional epithelium. The inventors coated Ova (25 μg Ova+/−25 μg CpG), peanut extract proteins (PE) (25 μg PE+/−25 μg CpG), or inactivated flu virus (A/PR/8/34 (H1N1)) (25/10 μg PR8) on the floss and administered 5 weekly doses for Ova and PE, and 3 bi-weekly doses for flu virus. Serum samples collected on day 56 (day 0 means day of first dose) clearly showed strong stimulation of systemic IgG responses towards Ova, PE, and PR8, and fecal matter analysis showed development of mucosal IgA and IgG. A clear adjuvant effect of CpG was seen, because responses, especially IgG2a, from use of CpG were significantly higher.

Determining if administration to junctional epithelium causes IgE production, which would show an allergic reaction. Serum IgE antibodies specific to Ova and PE were insignificant and comparable to mice receiving just floss (uncoated), suggesting that floss-based targeting of junctional epithelium does not induce allergies.

Flu vaccine administered at junctional epithelium is protective. Mice receiving inactivated PR8 as vaccine were challenged with 3×50% lethal dose. The figures show that mice were protected and exhibited minimal weight loss.

Using the present invention the effectiveness of floss with peanut extract (PE) or Ova for treatment of mice sensitized to peanut as food allergy model or Ova in an airway allergy model can be determined. For both allergy models, sublingual immunotherapy (SLIT) can be used as a positive control. Recently, FDA also approved a sublingual tablet for pollen allergy SLIT. SLIT requires a large amount of allergen to be placed under the tongue because permeability of this epithelium is not very high. For peanut immunotherapy, peanut sensitized mice received nine doses of 5 μg PE without CpG (Floss:PE) or with 5 μg CpG (Floss:PE+CpG) spread over 3 weeks. Two control groups were added: first group was of sensitized mice that received no treatment (Untreated), second was of naïve mice that received oral peanut challenge (Naïve mice with challenge only). Mice were challenged intraperitoneally with 500 μg of PE to assess treatment efficacy. As indicated by lower allergy-symptom clinical score, lower mast cell degranulation quantified through MCPT-1 marker, and lower infiltration of eosinophils in mouse intestinal tissue after challenge, floss provided superior desensitization over Untreated mice, and required fewer administrations (9) and lower doses. As expected, the peanut sensitized mice, which were untreated had significantly higher MCPT-1 and eosinophils in intestinal tissue. Naïve mice with challenge only had no abnormal readings after the challenge. Similarly, for Ova airway-allergy model, Ova sensitized mice received nine doses of 25 μg OVA without CpG (Floss:Ova) or with 25 μg CpG (Floss:Ova+CpG) in 3 weeks. A control group was added: sensitized mice that received no treatment (Untreated). Mice were challenged with three doses of 50 μg/day of Ova intranasally. The floss groups had lower inflammatory cells (eosinophils and neutrophils) and low mucus in lungs. The control untreated group showed significant inflammatory cells and mucus production. Mucus, which is a hallmark of airway allergic response was lower in the floss group, it suggests a better response at lower dose was stimulated.

To gain an insight into cellular responses, splenocytes of mice administered Ova were restimulated invitro with Ova (Note: These mice belonged to vaccination study and not the airway allergy). The cytokine profile showed that a both TH1 and TH2 effector response was being produced in mice receiving Ova+CpG. The bone marrow cells of these same mice without restimulation produced Ova-specific IgG and so did that of mice that received PE+CpG (vaccine study and not the foodway allergy). This shows that the response is systemic and not just local, and suggests generation of memory response, although more studies are required to confirm it.

These studies demonstrate that the floss can be coated, the coated floss can be used to target the junctional epithelium, which generates systemic and mucosal immune responses. The administration method also protected mice from lethal flu virus challenge and exhibited desensitization in airway allergy and peanut food allergy mouse models.

The inventors used a pipette tip to manually coat the floss using a solution containing the antigen/allergen. To increase reproducibility of coating and to increase delivery efficiency, an automated coating approach using computer-controlled linear stages and fluid dispensing systems can be used. A floss-coater can be used to coat a specific length of the floss with any antigen or allergen by simply switching out a coating liquid vial. Other options for coating include dip-coating, or spray coating, or ink jet printing, or pipette based coating, or cartridge printing or a combination thereof. The coating may require excipients such as thickening agents or surface tension reducing agents to improve coating and delivery efficiency. Additionally, to improve stability of molecules, trehalose and other substances known for protecting molecules from desiccating forces can be used. As shown herein, viral particles can be coated, thus it is possible to coat nanoparticles and microparticles since these might enhance the immune responses. Delivery efficiencies can be evaluated, and imaging can be used to characterize the coatings.

Develop a new paradigm for peanut allergen immunotherapy. The mouth is the first place where food makes contact with the body, and the chewed food particles have the potential to enter the gingival crevice and subsequently the tissues through the junctional epithelium. It is thus not surprising that the immune network in the gingiva may have a major role in maintaining tolerance. Indeed, proof-of-concept study using the coated floss for peanut allergen immunotherapy decreased sensitization. This approach provides for the rapid development of allergen immunotherapy for peanut and other food allergens. A floss can also be used for, e.g., peanut allergen immunotherapy by targeting junctional epithelium. The effect of dose of peanut allergen, frequency of flossing, use of adjuvants, use of particles to enhance phagocytosis and antigen processing, and delayed release coatings will be studied in the context of immunotherapy.

Administration into the gingival crevice can only be done after tooth eruption, which in humans occurs at 6-12 months. While the proposed paradigm may not become a mainstay in childhood vaccines until an infant is about 1 year old, the amplified immune responses resulting from the new paradigm will certainly impact and inform vaccine development, which could help cancer and HIV vaccines, and offer superior treatment for allergies, which are treated later in life for safety, and autoimmune diseases, which often appear late in life.

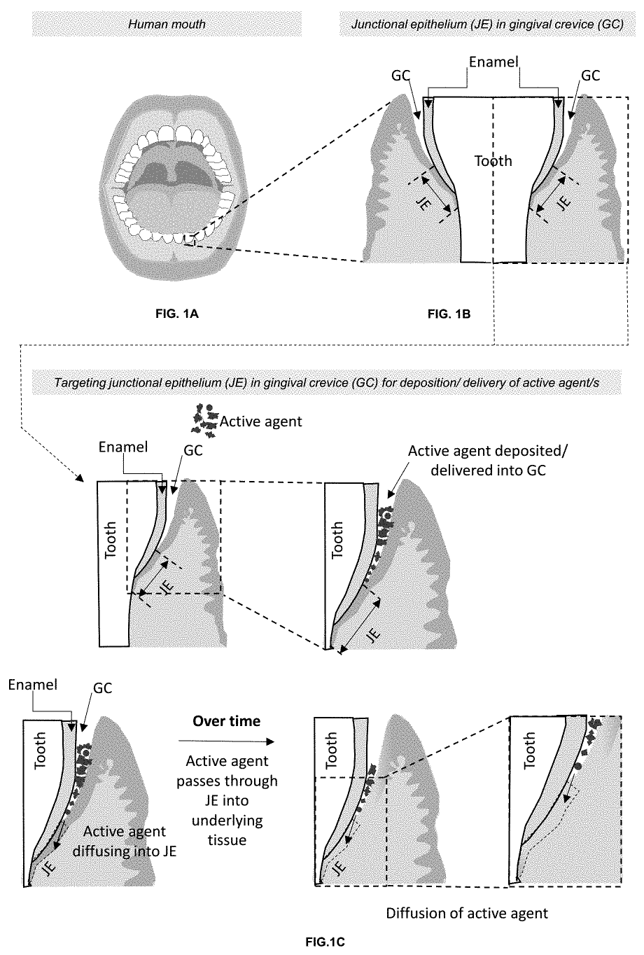

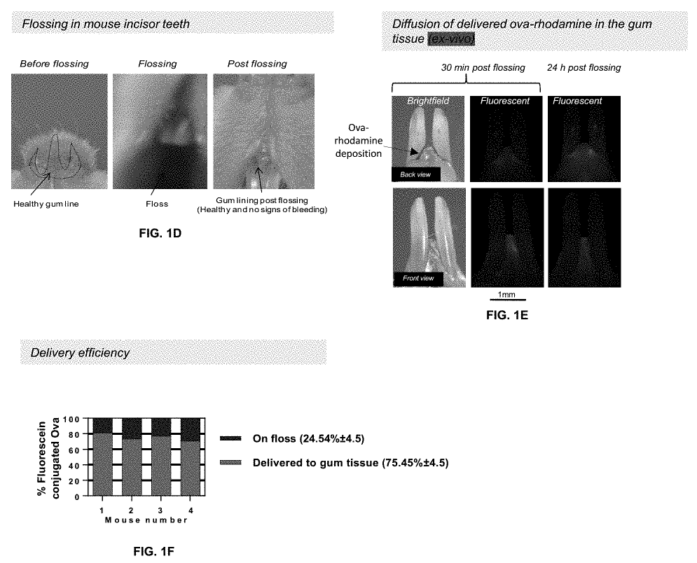

FIGS. 1A to 1F show the oral cavity route of immunization: (FIG. 1A) Human mouth. (FIG. 1B) Structure of gingival crevice and junctional epithelium (JE). (FIG. 1C) Delivery of active agent to junctional epithelium in gingival crevice and the diffusion of active agent in junctional epithelium and adjacent tissue over time, (FIG. 1D) delivery of antigen molecule coated on floss and effect of flossing on mouse gum tissue, and (FIG. 1E) diffusion of ovalbumin (Ova) conjugated to rhodamine in gum tissue. Flossing is performed, on each of the incisor tooth, by placing antigen deposited floss around the tooth and flossing for ten times so that the coated antigen gets deposited on the gum line. (FIG. 1F) Delivery efficiency of floss coated with fluorescein isothiocyanate (FITC) conjugated ovalbumin (Ova).

Targeting Junctional Epithelium in the Gingival Crevice for Vaccination Against Infectious Agents.

Example 1: Floss mediated delivery of Ovalbumin (Ova) to the junctional epithelium (JE) induces strong systemic and mucosal antibody response in mice (Vaccine angle).

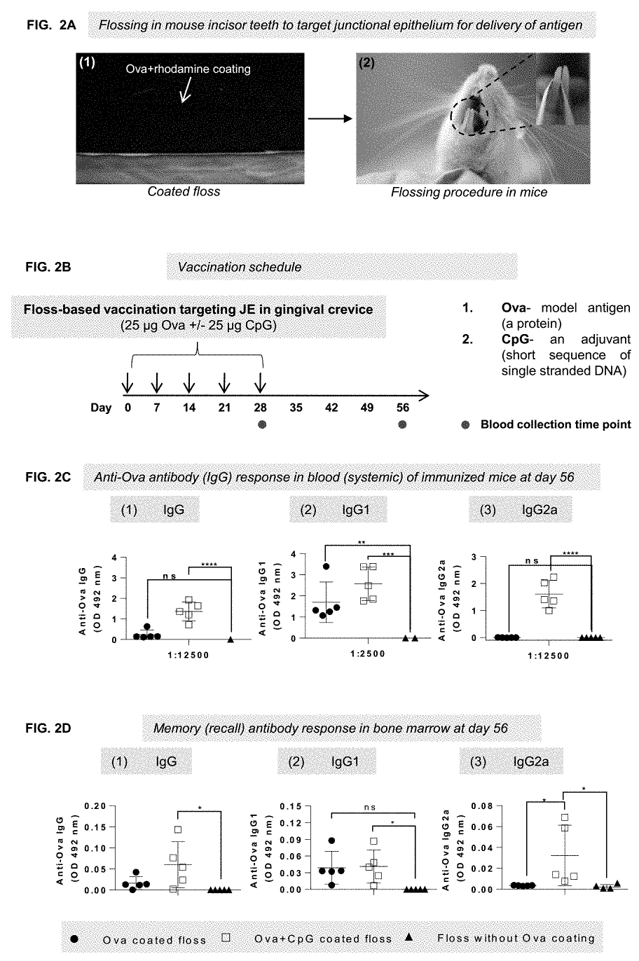

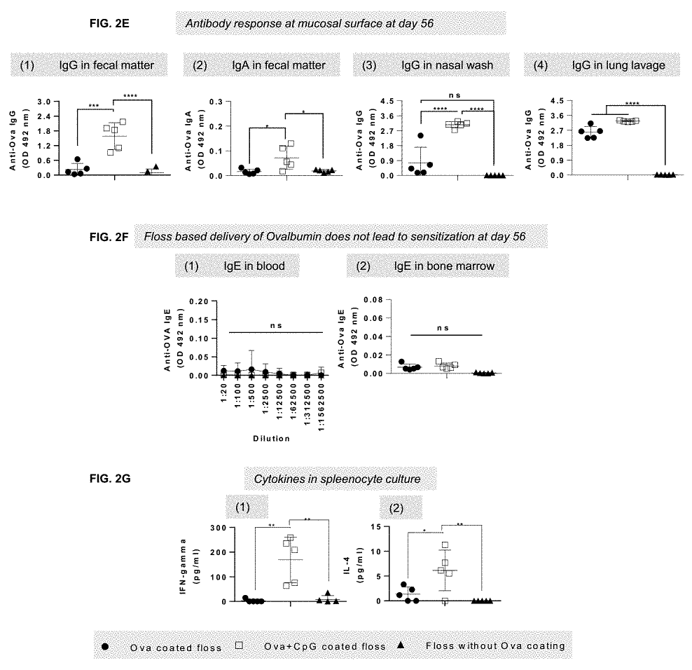

FIGS. 2A to 2G show floss-mediated vaccine delivery and characterization of immune response. (FIG. 2A)(1) Coated floss stereomicrograph and FIG. 2A(2) flossing procedure in mice. (FIG. 2B) Vaccination schedule: Balb/c mice (n=5) were vaccinated by flossing antigen (Ovalbumin (Ova), a model antigen) deposited floss on their gums. Floss included a deposit of 25 μg Ova+/−25 μg CpG (single-stranded oligodeoxynucleotide adjuvant) and mice were vaccinated weekly, up to 4 weeks total. Mice treated with floss without any coating were treated as control. Systemic immune response: Mice were bled at day 28 and 56, and anti-Ova antibody response (at either 1:12500 or 1:2500 dilution) in serum was analyzed through enzyme-linked immunosorbent assay (ELISA). FIG. 2(C)(1)-(3) Anti-Ova antibody response at day 56—FIG. 2(C) (1) IgG, FIG. 2(C)(2) IgG1 and FIG. 2(C)(3) IgG2a. Individual mouse serum was used in analysis. FIG. 2(D)(1)-(3) shows the memory immune response: Vaccinated mice were euthanized, and bone marrow cells were collected. Cells were cultured in triplicates in a concentration of 1×10⁶ cells per well with RPMI medium supplemented with 10% fetal bovine serum and penicillin-streptomycin antibiotics. Supernatant of cultured cells were collected post 96 h and anti-Ova responses were analyzed. FIG. 2(D)(1)-(3) Anti-Ova antibody response in bone marrow cells—FIG. 2(D)(1) IgG, FIG. 2(D)(2) IgG1, FIG. 2(D)(3) IgG2a. This result suggests that the response is not just local and systemic but was able to induce a memory response to better prepare individual for future exposure to same antigen (Ag). FIG. 2(E)(1)-(4) show the mucosal immune response. At day 56, fecal matter, nasal wash and lung lavage were collected from the vaccinated and mice that were treated with floss only. Anti-Ova FIG. 2(E)(1) IgG in fecal matter (1:5 dilution), FIG. 2(E)(2) IgA in fecal matter (1:5 dilution), FIG. 2(E)(3) IgG in nasal wash (undiluted), and FIG. 2(E)(4) IgG lung lavage (undiluted). FIG. 2(F)(1)-(2) No significant amount of IgE was detected either (1) in the serum or (2) in the bone marrow of the mice vaccinated through floss indicating that the target site of JE does not sensitize the individual against the delivered Ag. FIG. 2(G) Vaccinated mice were euthanized and splenocyte cells were collected. Cells were cultured, re-stimulated by Ova (200 m/ml) in triplicates in a concentration of 1×10⁶ cells per well with RPMI medium supplemented with 10% fetal bovine serum and penicillin-streptomycin antibiotics. Supernatant of cultured cells were collected post 96 h and cytokine levels were analysed. FIG. 2(G) shows cytokine levels in spleenocyte culture, FIG. 2(G)(1) IFN-gamma, and FIG. 2(G)(2) IL-4. Data represented as mean±SD. One-way ANOVA test was used to compare between the groups at different serum dilutions. *p<0.05, **p<0.01, ***p<0.001, and ****p<0.0001.

Example 2: Floss mediated delivery of Inactivated (Inac.) Influenza Virus to the junctional epithelium (JE) induces strong systemic antibody response and protects mice from a lethal challenge.

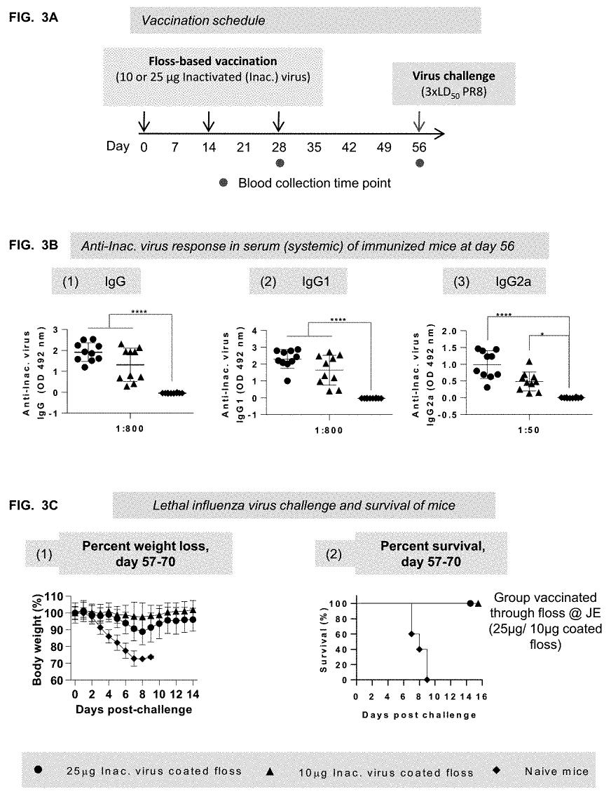

FIGS. 3A to 3C show a floss deposited for influenza vaccination. FIG. 3(A) Vaccination schedule: Balb/c mice (n=10) were vaccinated either with 10 μg or 25 μg of Inactivated (Inac.) virus coated on a floss for a total of three times—once on each of day 0, 14 and 28. At day 56, mice were bled and anti-Inac. virus immune response (at either 1:800 or 1:50 dilution) was analyzed through ELISA. FIG. 3(B)(1)-(3) Anti-Inac. virus FIG. 3(B)(1) IgG, FIG. 3(B)(2) IgG1, FIG. 3(B)(3) IgG2a antibody response in serum at day 56. Virus challenge: At d56, mice were challenged with 3×LD₅₀ (lethal dose 50%) of A/PR/8/34 (H1N1) influenza virus. Individual mice samples were used in analysis. Data represented as mean±SD. One-way ANOVA test was used to compare between the groups. *p<0.05, **p<0.01, ***p<0.001, and ****p<0.0001. FIG. 3(C)(1)-(2) Mice were observed every day for change in the body weight and severity of infection. FIG. 3(C)(1) Percent change in body weight, FIG. 3(C)(2) percent survival rate of vaccinated mice after infection. n=5 mice in each group.

Example 3: Floss mediated delivery of M2e gold nanoparticle (AuNP) conjugate based universal influenza vaccine to the junctional epithelium (JE) induces strong systemic antibody response and protects mice from a lethal challenge.

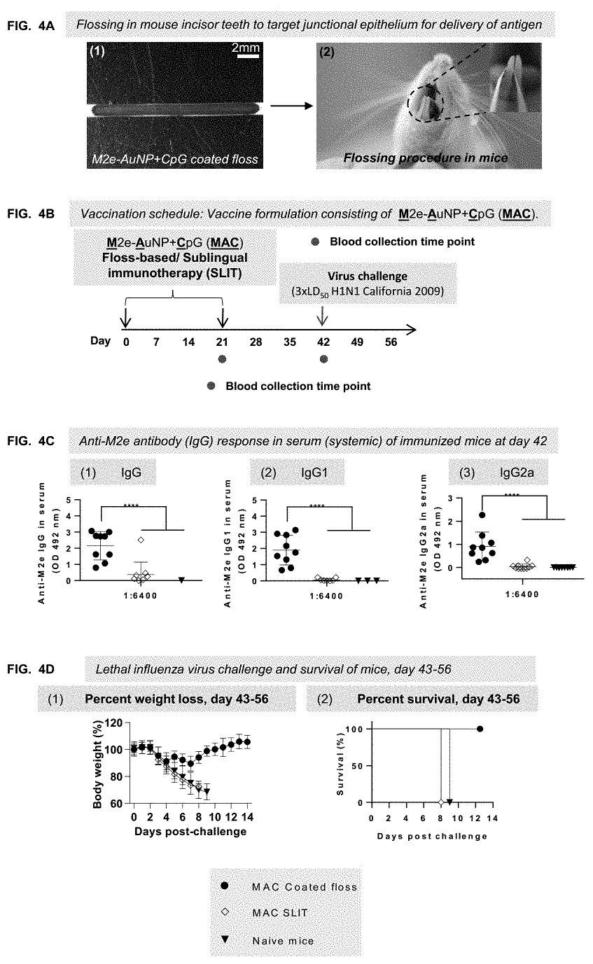

FIGS. 4A to 4D show floss-mediated delivery of M2e-AuNP+CpG (MAC), a vaccine formulation consisting of a peptide (M2e) conjugated to gold nanoparticles (AuNP's) further supplemented with an adjuvant (CpG), vaccine and characterization of immune response. FIG. 4(A)(1) Stereomicrograph of floss coated with M2e-AuNP+CpG containing 56 μg of AuNP's, 8.1 μg of M2e and 20 μg of CpG (1× dose) and FIG. 4(A)(2) flossing procedure in mice. FIG. 4(B) Vaccination schedule: Balb/c mice (n=10) were vaccinated by either flossing vaccine formulation [M2e-AuNP+CpG (MAC)] coated floss on their gums or by placing the vaccine formulation [M2e-AuNP+CpG (MAC)] under tongue [sublingual immunotherapy (SLIT)]. Vaccine formulation (MAC), either coated on floss or delivered through SLIT, consisted of 56 μg of AuNP's, 8.1 μg of M2e and 20 μg of CpG (single-stranded oligodeoxynucleotide adjuvant) and mice were vaccinated on day 0 and day 21. Naïve mice that received no treatment were treated as control. Systemic immune response: Mice were bled at day 21 and 42, and anti-M2e antibody response (at 1:6400 dilution) in serum was analyzed through enzyme-linked immunosorbent assay (ELISA). FIG. 4C(1)-(3) Anti-M2e antibody response in serum at day 42—FIG. 4C(1) IgG, FIG. 4C(2) IgG1 and FIG. 4C(3) IgG2a. Individual mouse serum was used in analysis. Data represented as mean±SD. One-way ANOVA test was used to compare between the groups. *p<0.05, **p<0.01, ***p<0.001, and ****p<0.0001. Virus challenge. (FIG. 4D(1)-(2)) At day 43, mice were challenged with 3×LD₅₀ (lethal dose 50%) of A/California/07/2009 H1N1 virus. Mice were observed every day for change in the body weight and severity of infection. FIG. 4D(1) Percent change in body weight, FIG. 4D(2) percent survival rate of vaccinated mice after infection. n=5 mice in each group.

Targeting Junctional Epithelium in the Gingival Crevice for Allergen-Specific Immunotherapy.

Example 4: Floss mediated delivery of Peanut Extract (PE) to the junctional epithelium (JE) induces strong systemic and mucosal antibody response in mice (Vaccine angle).

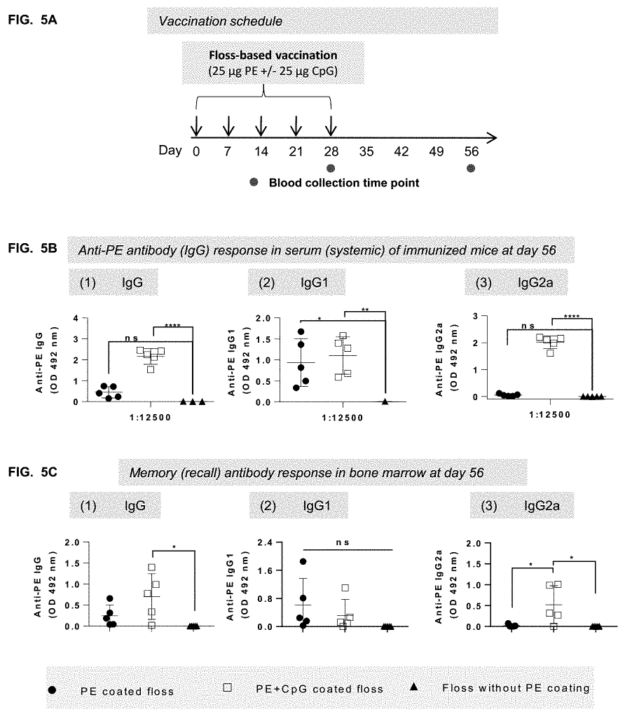

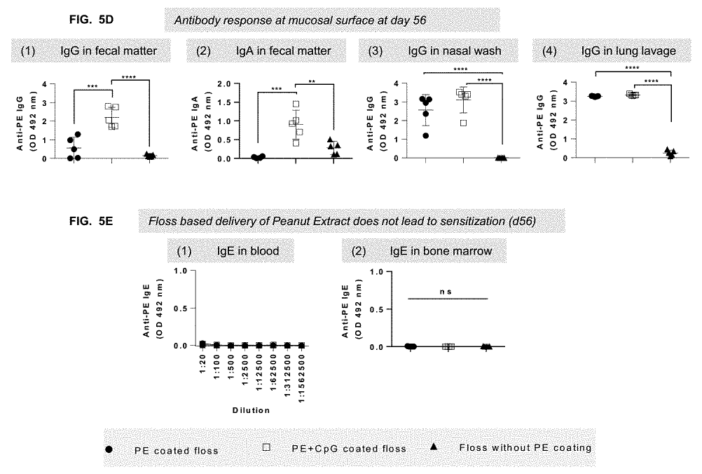

FIGS. 5A to 5E show floss-mediated vaccine delivery and characterization of immune response. (FIG. 5A) Vaccination schedule: Balb/c mice (n=5) were vaccinated by flossing antigen (Peanut extract (PE)) deposited floss on their gums. Floss was deposited with 25 μg PE+/−25 μg CpG (single-stranded oligodeoxynucleotide adjuvant) and mice were vaccinated weekly, up to 4 weeks total. Mice treated with floss without any coating or deposits were treated as control. Systemic immune response: Mice were bled at day 28 and 56, and anti-PE antibody response (at 1:12500 dilution) in serum was analyzed through enzyme-linked immunosorbent assay (ELISA). FIG. 5B(1)-(3) Anti-PE antibody response in serum at day 56—FIG. 5B(1) IgG, FIG. 5B(2) IgG1 and FIG. 5B(3) IgG2a. Individual mouse serum was used in analysis. (FIG. 5C(1)-(3)) Memory Immune response: Vaccinated mice were euthanized, and bone marrow cells were collected. Cells were cultured in triplicates in a concentration of 1×10⁶ cells per well with RPMI medium supplemented with 10% fetal bovine serum and penicillin-streptomycin antibiotics. Supernatant of cultured cells were collected post 96 h and anti-PE responses were analyzed. Anti-PE FIG. 5C(1) IgG, FIG. 5C(2) IgG1, FIG. 5C(3) IgG2a. This result suggests that the response is not just local and systemic but was able to induce a memory response to better prepare individual for future exposure to same antigen (Ag). (FIG. 5D) Mucosal immune response. At day 56, fecal matter, nasal wash and lung lavage were collected from the vaccinated and naïve mice. Anti-PE FIG. 5D(1) IgG in fecal matter (1:5 dilution), FIG. 5D(2) IgA in fecal matter (1:5 dilution), FIG. 5D(3) IgG in nasal wash (undiluted), and FIG. 5D(4) IgG lung lavage (undiluted). (FIG. 5E(1)-(2)) No significant amount of IgE was detected either FIG. 5E(1) in the serum or FIG. 5E(2) in the bone marrow of the mice vaccinated through floss indicating that the target site, junctional epithelium, does not sensitize the individual against the delivered Ag. Data represented as mean±SD. One-way ANOVA test was used to compare between the groups at different serum dilutions. *p<0.05, **p<0.01, ***p<0.001, and ****p<0.0001.

Example 5: Floss mediated delivery of Peanut Extract (PE) to the junctional epithelium (JE) induces strong systemic antibody response in mice (Therapeutic regime). Targeting JE for immunotherapy of ‘Food Allergies’.

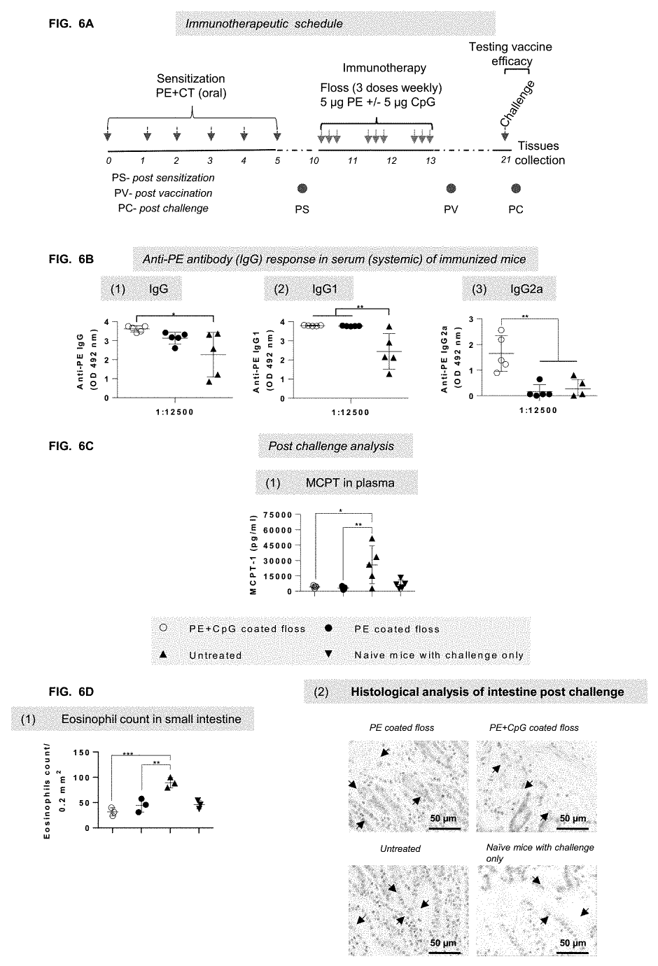

FIGS. 6A to 6D show a peanut allergen immunotherapy schedule. (FIG. 6A) Immunotherapeutic schedule: Balb/c mice (n=5) were sensitized through oral route [1 mg peanut extract (PE)+15 μg cholera toxin (CT)], given at intervals of a week for five consecutive weeks. Mice were then vaccinated by flossing antigen-coated floss. Floss was coated with 5 μg PE+/−5 μg CpG (single-stranded oligodeoxynucleotide adjuvant) and mice were vaccinated three times per week, up to 3 weeks total. Sensitized mice that did not receive any treatment were kept as control (untreated). Mice were bled at day 10 post-vaccination (PV). Mice were challenged eight weeks post-vaccination with PE allergen (500 μg) through intraperitoneal route (IP), were then euthanized and different tissues were collected. (FIG. 6B(1)-(3)) Anti-PE antibodies in serum (at 1:12500 dilution) were confirmed through enzyme-linked immunosorbent assay (ELISA). Anti-PE FIG. 6B(1) IgG, FIG. 6B(2) IgG1 and FIG. 6B(3) IgG2a antibody response at day 10 post-vaccination. Individual mouse serum was used in analysis. Data represented as mean±SD. One-way ANOVA test was used to compare between the groups at different serum dilutions. *p<0.05, **p<0.01, ***p<0.001, ****p<0.0001.and ns: not significant. PE induced anaphylaxis. (FIG. 6C) (1) Plasma MCPT-1 levels post IP challenge with PE. Histological analysis of intestinal tissue. (FIG. 6D) Eight weeks post-vaccination, mice were challenged with PE allergen (500 μg) through intraperitoneal route. Mice were then euthanized, and small intestine was collected from proximal, middle and distal ends, fixed, dehydrated and embedded in paraffin wax for cutting. Tissue sections were stained with hematoxylin and eosin (H&E) stain and sectioned for histology. FIG. 6D(1) Number of eosinophils counted in respective sections from mice of different treatment groups. FIG. 6D(2) Brightfield image of H&E stained intestine with arrows pointing to eosinophil infiltration. Individual mouse sample was used in analysis. Data represented as mean±SD. One-way ANOVA was used to compare between the groups. *p<0.05, **p<0.01, ***p<0.001 and ns: not significant.

Example 6: Floss mediated delivery of Ovalbumin (Ova) to the junctional epithelium (JE) induces strong systemic antibody response in mice (Therapeutic regime). Targeting JE for immunotherapy of ‘Airway Allergies’.

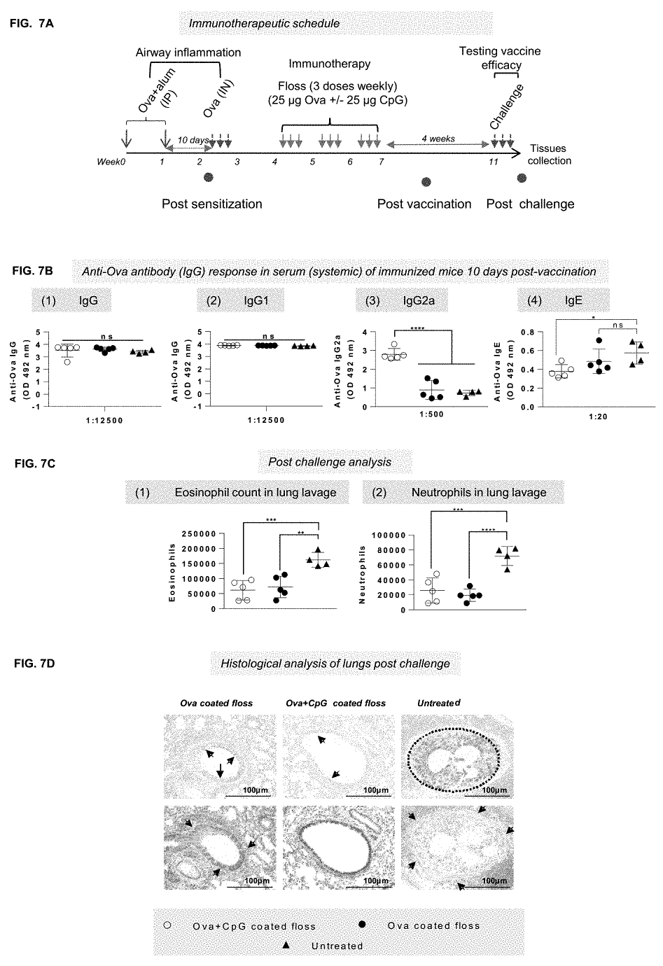

FIGS. 7A to 7D show airway allergen immunotherapy. (FIG. 7A) Immunotherapeutic schedule: Balb/c mice (n=5) were sensitized through two intraperitoneal (IP) injection (25 μg Ova+2 mg of alum (an adjuvant)), given at interval of a week. Ten days post sensitization (PS), mice were challenged with Ova (50 μg) through intranasal route (IN) for three consecutive days to develop airway inflammation. Mice were then vaccinated by flossing antigen-deposited floss. Floss was coated with 25 μg Ova+/−25 μg CpG (single-stranded oligodeoxynucleotide adjuvant) and mice were vaccinated three times per week, up to 3 weeks total. Sensitized mice that did not receive any treatment were kept as control (untreated). Mice were bled at day 10 post-vaccination. Mice were challenged on day 28 post-vaccination with Ova allergen (50 μg) through intranasal route (IN) for three consecutive days, were then euthanized and different tissues were collected Systemic immune response: (FIG. 7B(1)-(4)) Anti-Ova FIG. 7B(1) IgG, FIG. 7B(2) IgG1, FIG. 7B(3) IgG2a and FIG. 7B(4) IgE antibody response in serum (at either 1:12500 or 1:500 or 1:20 dilution) at day 10 post-vaccination analyzed through enzyme-linked immunosorbent assay (ELISA). (FIG. 7C) Lung lavage analysis post-challenge. Mice were then euthanized, and mucosal secretion of lung lavage was collected. Cell count of FIG. 7C(1) eosinophils and FIG. 7C(2) neutrophils in lung lavage-cells were stained with diff-stain kit and counted by observing cells under confocal microscope. Histological analysis of lungs: (FIG. 7D) Mice were then euthanized, and lungs were harvested, fixed, cleaned and sectioned for histology. Tissue sections were stained with either periodic acid-Schiff (PAS) to stain for mucus deposition or trichrome blue (TCB) to stain for collagen deposition. Representative brightfield image of PAS stained lung (top panel) and TCB stained lung (bottom panel). Arrows in the top panel point to mucus deposition, and to collagen deposition in the bottom panel.

Example 7. Method/s for deposits on dental floss.

The majority of the floss available in the market are coated with a continuous coating of materials (such as wax, flavoring, etc.). Currently, the entire floss length (hundreds of feet in a floss cartridge) is coated. These coatings are not properly characterized and cannot be used for medical applications, because it is important to deliver a known quantity of the medication such as in the case of delivering a vaccine or delivering a drug/therapeutic molecule where deviations from recommended dose can be detrimental or may cause side effects.

The compositions and methods of the present invention address coating of any molecule in a simple manner through fluid dispensing. The method can be used to coat one or more active agents/molecules on the specific length of the floss, specific surfaces of the floss and even at a discrete location. Also, the method can be used to coat both sides if needed.

The present invention provides a novel way to coat a dental floss. A substance (for example a synthetic molecule or polymer, amino acid or its polymer, nucleotide or its polymer, lipids, carbohydrates, natural material, antigen/allergen/adjuvant/drug/combinations thereof) can be coated on surface of the floss for its delivery into the gum tissue. The delivery may have any intended use for example to modulate immune response, systemic effect, or local effect. Surface of the floss can be coated by depositing the biologics (the deposition process deposits on a single contiguous portion of the floss, or on two or more discrete portions of the floss with same or different spacing between the each said deposited region) over a shorter or a longer distance/length of floss (the deposition process comprises placing liquid drops on the floss, or dragging the liquid drop(s) on the floss to spread it over a certain distance/length on the floss using a pipette, or spray coating, or ink jet printing, or pipette based coating, or cartridge printing or a combination thereof), and letting the coating to dry. To substantiate the current invention, we have shown effectiveness and proof-of-concept using antigens/allergens/peptides/micro-particles/nano-particles/single stranded deoxyribonucleic acid (DNA). Varying amounts of the biologics can be coated on the surface of the floss. The coated material can be easily delivered into the gum tissue by a simple action of flossing.

For the purpose of medical application using a coated floss, it is important to have the following properties: (a) the coating should be consistent over the short length of the coated floss to enable consistent delivery into the gum pocket by the user; (b) known amounts of formulations should be coated on the floss; and/or (c) The coating should stay adhered to the surface until intended use.

Floss is often made of material that is hydrophobic (such as TEFLON® or NYLON) and it is difficult to wet these surfaces using a coating solution. Because of poor wetting, continuous and uniform coatings are difficult to achieve on the floss. While many different solvents can be used to make the coating solution, water is preferred for biological material that must be coated on the floss, and water-based coating solutions are even harder to coat on the floss. However, non-aqueous solutions can also be used with the present invention in which the active agent is in a solvent that is not soluble in water (or partially soluble) and the active agent is deposited onto the floss, and the solvent is evaporated leaving the active agent.

Instead of making a continuous coating, discrete drops of liquid can be deposited on the floss surface. By doing so, there is less need to uniformly spread the coating across a length, and reproducible coatings and patterns can be achieved. (1) Drops can be placed on the floss using fluid dispensing systems (manual or automated or their combinations). For proof of concept, manual dispensing was done. (2) The surface of the floss maybe made hydrophilic (for example by coating with a hydrophilic polymer, or for example by oxygen plasma treatment, or other conventional surface treatment approaches that can change the surface energy of the floss surface to better allow for the spreading of the coating liquid. (3) Place the coating liquid on the floss surface. After a certain period and after sufficient solvent has evaporated, the liquid on the floss can be mechanically spread. After some solvent has evaporated, the viscosity of the coating liquid increases, and the ability to spread it over the floss improves.

Advantages of using dispensing system (manual, automated, or a combination thereof) for depositing floss: (1) lesser loss of depositing formulation as compared to spray/dip coating; (2) depositing of a precise amount; (3) depositing of multiple deposited formulations; and/or (4) surface modification of the floss can be avoided since even water-based solutions can be deposited as drops to create uniform patterns.

Spray or dip coating can lead to wastage of material. In contrast use of depositing into discrete deposits on the surface of the floss leads to almost none to minimal loss of material. With depositing on the floss, precise control (for example if the goal is to deposit a small spot say less than 1 mm in length/diameter of the floss) is difficult to achieve. However, with fluid dispensing, even nanoliter to picoliter amounts can be simply deposited on the floss at known and precise locations. With fluid dispensing, it is straightforward to also deposit different material(s) with a small gap between the different deposited spots. This level of accuracy and precision is difficult with spray/dip coating. The approach could be used to develop and build depositing devices, which may be placed in pharmacies, homes, or clinician offices. Furthermore, using the proposed invention, active agent with a different solvent requirement for solubility (for example, one active agent, an antigen, with water as a solvent whereas the other active agent, an adjuvant, with organic solvent requirement) can be deposited on floss.

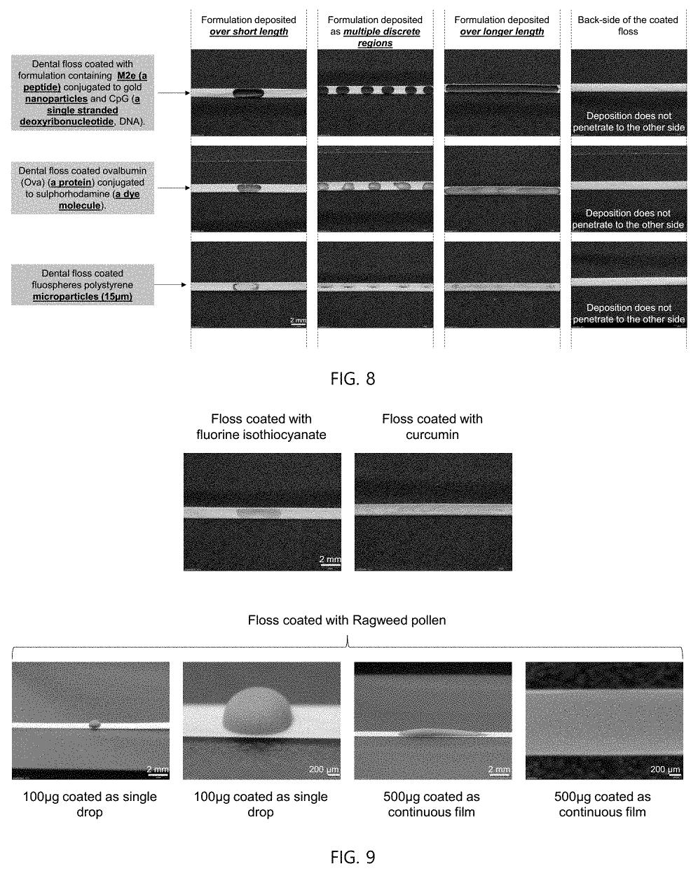

FIG. 8 shows the deposition capabilities, deposition of floss with peptide, nanoparticles, protein, oligonucleotide, microparticles, in different patterns of deposition either as a single region of deposition with a short length or a longer length, or multiple discrete regions of deposition, and only on one side of the floss.

FIG. 9 shows the deposition capabilities, of depositing water soluble and water insoluble materials including pollen grain microparticles.

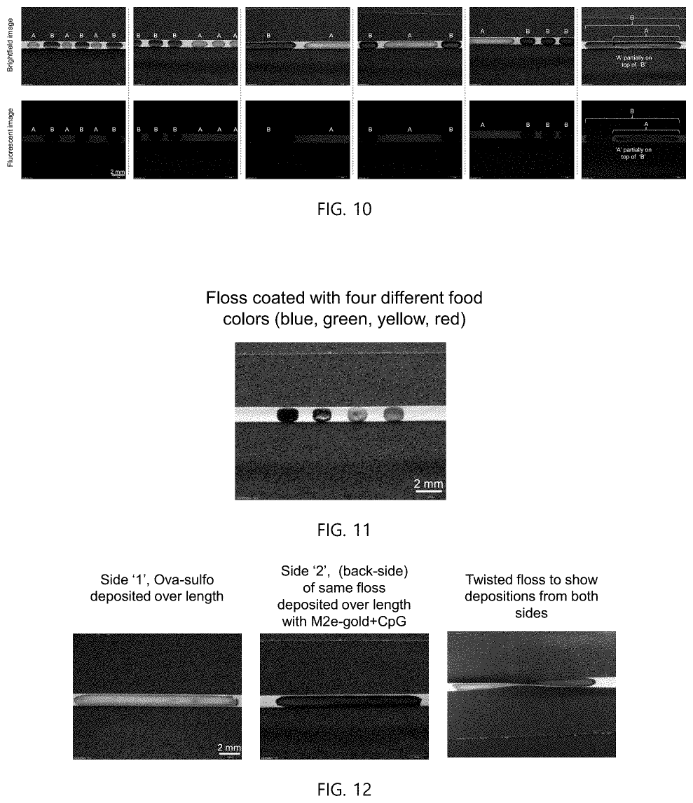

FIG. 10 shows the deposition capabilities, and different deposition patterns with two different compounds as example. One formulation was ovalbumin (protein) conjugated to NHS-Rhodamine (fluorescent reagent) in water—called as ‘A’, and second was M2e peptide conjugated to gold nanoparticles and CpG (single stranded DNA) in water—called as ‘B’.

FIG. 11 shows the deposition capabilities of multiple materials, shown here are four different food colors (blue, green, yellow, red) deposited as four distinct portions.

FIG. 12 shows the coating capabilities for coating two sides of floss with different formulations.

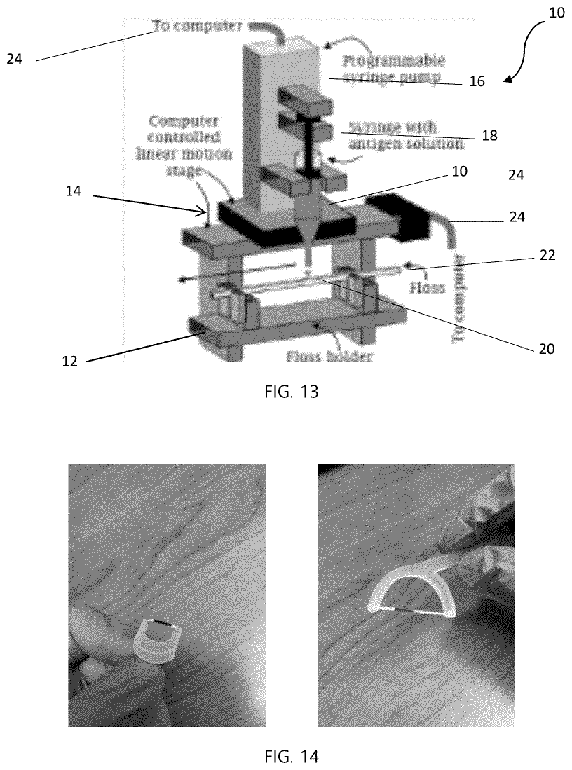

FIG. 13 shows an example of an automated coating station 10 to coat floss. The automated coating station 10 includes a stand 12 that includes a controlled linear motion stage 14 that permits movement in one or two dimensions, shown in this embodiment with a two-dimensional stage, with a back 16 onto which a syringe assembly 18 is attached that controls the delivery of drop(s) 20 onto a floss 22. The stage is controlled by a computer 24, which can be connected to the controlled linear motion stage 14 and/or the syringe assembly 18.

FIG. 14 shows two examples of the design of the flosser system.

Example 8. Micronutrient delivery to gum pocket.

The objective of this example was to provide a method of delivering micronutrients (such as vitamins and minerals) to a mammalian subject via their gum pocket using a floss coated with the said micronutrient(s). The process comprises: (1) taking a floss coated with the micronutrient(s), (2) inserting the floss into the gum pocket, (3) and flossing.

In certain embodiments, the floss may be coated with a single micronutrient. In another embodiment, the floss may be coated with multiple micronutrients either mixed together or individually on the same floss.

Some micronutrients are water-soluble and some can be water insoluble or can have poor water solubility. The objective is to obtain uniformity of composition and reproducibility of dose when coating more than one micronutrient as a mixture on the floss. To do this any approach can be followed including: (1) Using a co-solvent system (such as a polar solvent like water+organic solvent like ethanol) that allows solubilization of all micronutrients in question; and/or (2) forming stable suspensions such that some micronutrients are fully soluble in the solvent system while others are suspended as particles to form homogenous suspensions or emulsions. These suspended micronutrients may also have partially solubilized molecules that solubilize in the solvent system.

To allow for the formation of reproducible coatings, the base material of the floss can be modified chemically or physically or a combination thereof. For example, the floss material can be coated with a material including polymers that can change the surface properties such as surface energy to make the wetting tendency of the floss surface more amenable to coating. An example of this material can be poly(lactic-co-glycolic acid). The base material can be exposed to oxygen, ozone, plasma, or other gases and radiative sources. The base material can be selected besides the ones commonly used in flosses (Teflon® and nylon are the most common, although silk and other natural fibers also exist).

Micronutrient(s) may be formulated in a manner that changes their release kinetics such as slow-release formulations. This can be achieved in numerous ways: (1) encapsulating micronutrient(s) in particles individually or in combinations; and/or (2) formulating a water-soluble and water-insoluble (poorly soluble) micronutrient together whereby the water-insoluble (poorly soluble) micronutrient acts as the slow-release component without the need for an extra ingredient.

Micronutrients that are highly water-soluble may be formulated in a manner that increases their residence time in the gum pockets to allow for better bioavailability. The floss can be of a solid material or a braided structure.

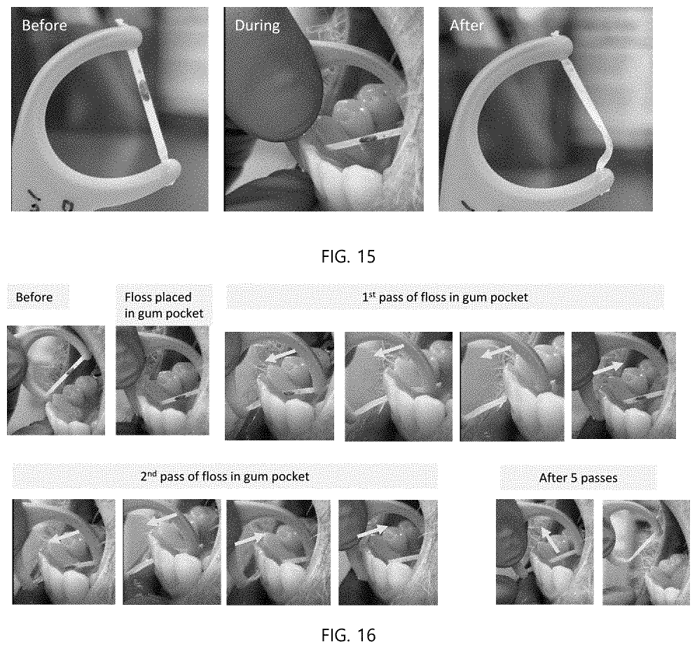

FIG. 15 shows a floss coated with vitamins B1, B12 and D. The coated floss was passed in gum pocket and majority of the coating is deposited in the gum pocket.

FIG. 16 shows passing of floss in teeth. Majority of the coated vitamin mixture (B1, B12 and D) is deposited in about 2 passes of the floss.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

What is claimed is:

1. A method of delivering one or more nutrients to a subject comprising:
delivering an effective amount of one or more nutrients into a gingival crevice wherein the amount is sufficient to supplement the diet of the subject for the nutrients.

2. The method of claim 1, wherein the one or more nutrients are not targeted for delivery to a vestibular mucosa.

3. The method of claim 1, wherein the one or more nutrients target an epithelium in the gingival crevice, a crevicular epithelium, a junctional epithelium, or combinations thereof.

4. The method of claim 1, wherein the one or more nutrients are encapsulated to maximize delivery of the one or more nutrients.

5. The method of claim 1, further comprising adding one or more agents that increase permeability of the one or more nutrients into the epithelium of the gingival crevice.

6. The method of claim 1, wherein between 0.001%-100% of the one or more nutrients is in a depot at a junctional epithelium (JE) of the gingival crevice.

7. The method of claim 1, wherein the one or more nutrients are provided repeatedly to a junctional epithelium of the gingival crevice.

8. The method of claim 1, wherein delivery of one or more nutrients to a junctional epithelium is after consumption of a food or drink, or brushing of teeth.

9. The method of claim 1, wherein the one or more nutrients is applied once or more than once with a frequency on a daily or weekly or monthly basis, such as 1, 2, 3, 4, 5, or 6 times daily or 1, 2, 3, 4, 5, 6, or 7 times weekly, or 1, 2, 3, or 4 times monthly.

10. The method of claim 1, wherein the one or more nutrients provide 10%, 20%, 30%, 40%, 50%, 60%, 70%, 80%, 90% or 100% of the daily dietary requirement by flossing 1, 2 or 3 times a day.

11. The method of claim 1, wherein delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks liquid, or brushing of teeth.

12. The method of claim 1, wherein delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks liquid, or brushing of teeth.

13. The method of claim 1, wherein the amount of the one or more nutrients delivered to a crevicular epithelium, a junctional epithelium, or combinations thereof from picograms to milligrams.

14. The method of claim 1, wherein the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K.

15. A nutrient delivery system comprising an effective amount of one or more nutrients on a delivery device that targets a junctional epithelium at a gingival crevice, wherein an amount of the one or more nutrients is a nutritionally effective amount.

16. The nutrient delivery system of claim 15, wherein the one or more nutrients are not delivered to a vestibular mucosa.

17. The nutrient delivery system of claim 15, wherein the delivery device comprises a cross-sectional shape that maximizes delivery of the one or more nutrients into the gingival crevice.

18. The nutrient delivery system of claim 15, further comprising one or more agents that increase a permeability of the one or more nutrients into an epithelium in the gingival crevice, a crevicular epithelium, a junctional epithelium, or combinations thereof.

19. The nutrient delivery system of claim 15, wherein between 0.001%-100% of the one or more nutrients is in a depot at a crevicular epithelium, a junctional epithelium, or combinations thereof, of the gingival crevice.

20. The nutrient delivery system of claim 15, further comprising one or more pharmaceutically acceptable carriers, excipients, diluents, buffers, or salts.

21. The nutrient delivery system of claim 15, wherein the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K.

22. A method of making a floss that comprises a pre-determined amount of one or more nutrients comprising:
providing a floss; and
depositing on the floss one or more deposits of the one or more nutrients in a pharmacologically acceptable carrier, wherein each deposit has a known, pre-determined amount of the one or more nutrients.

23. The method of claim 22, wherein each adjacent deposit comprises the same one or more nutrients or different one or more nutrients, or each adjacent deposit comprises the same one or more nutrients in a different concentration; or wherein each adjacent deposit comprises different one or more nutrients in a different concentration; or each adjacent deposit is placed on a different plane from the adjacent deposit; or each adjacent deposit is placed on an opposite side of the floss from the deposit; or adjacent deposits each comprise different one or more nutrients from a prior adjacent deposit.

24. The method of claim 23, wherein each adjacent deposit comprises different one or more nutrients with different solvent requirements selected from one or more nutrients with solubility in water-based solvent/s and the other one or more nutrients with solubility in organic solvent/s.

25. The method of claim 23, wherein two or more nutrients are deposited on top of one another in form of deposit with the same or different distance/lengths.

26. The method of claim 25, wherein the one or more nutrients with different solvent requirements are deposited on opposite sides over the same or different distance/lengths.

27. The method of claim 25, wherein the one or more nutrients with same solvent requirement are deposited on top of one another with the same or different distance/lengths.

28. The method of claim 23, wherein the one or more nutrients with different solvent requirement are deposited on opposite side with the same or different distance/lengths.

29. The method of claim 22, wherein the floss is solid, frayed, comprises multiple strands, has been treated to be adhesive, has been treated to adhere to the pharmacologically acceptable carrier, or has been treated to adhere to the active agent.

30. The method of claim 22, wherein each adjacent deposit comprises a dye or indicia that distinguishes between adjacent drops or patches.

31. The method of claim 22, wherein the floss is not dipped into the one or more nutrients, the pharmacologically acceptable carrier, or both.

32. The method of claim 22, wherein the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K.

33. The method of claim 22, wherein the floss has a thickness less than 5 mm, preferably less than 3 mm, and preferably less than 1 mm, or preferably 35 to 175 microns.

34. The method of claim 22, wherein the floss comprises natural or synthetic polymers, organic materials, metals, inorganic materials or combinations thereof.

35. The method of claim 22, wherein the floss comprises a mucoadhesive layer or a hydrophobic layer or a hydrophilic layer or a combination.

36. The method of claim 22, wherein the floss comprises a microporous structure allowing diffusion of the one or more nutrients to gingival crevice.

37. The method of claim 22, wherein the floss delivers the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks liquid, or brushing of teeth.

38. The method of claim 22, wherein the floss delivers the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks liquid, or brushing of teeth.

39. The method of claim 22, wherein a viscosity of the deposit is 0.01 centipoise (cp), 1 cp, 10 cp, 100 cp, 1000 cp, 10000 cp, 100000 cp, 200000 cp, 300000 cp, 500000 cp, 1000000, or 100000000 cp.

40. A floss that comprises a pre-determined amount of one or more nutrients comprising:
a floss; and
a deposit on the floss one or more depots of the one or more nutrients in a pharmacologically acceptable carrier, wherein each droplet or patch has a known, pre-determined amount of the active agent.

41. The floss of claim 40, wherein each adjacent deposit comprises the same one or more nutrients or different one or more nutrients, or each adjacent deposit comprises the same one or more nutrients in a different concentration; or wherein each adjacent deposit comprises different one or more nutrients in a different concentration; or each adjacent deposit is placed one a different plane from the adjacent deposit; or each adjacent deposit is placed on an opposite side of the floss from the adjacent deposit; or adjacent deposit each comprise different one or more nutrients from a prior adjacent deposit.

42. The floss of claim 41, wherein each adjacent deposit comprises of one or more nutrients with different solvent requirements, selected from one or more nutrients with solubility in water-based solvent/s and the one or more nutrients with solubility in organic solvent/s.

43. The floss of claim 41, wherein one or more nutrients are deposited on top of one another in form of drop or patch with the same or different distance/lengths.

44. The floss of claim 42, wherein one or more nutrients with different solvent requirements are deposited on opposite sides over the same or different distance/lengths.

45. The floss of claim 44, wherein the one or more nutrients with same solvent requirement are deposited on top of one another with the same or different distance/lengths.

46. The floss of claim 41, wherein the one or more nutrients with different solvent requirement are deposited on opposite side with the same or different distance/lengths.

47. The floss of claim 41, wherein the floss is solid, frayed, comprises multiple strands, has been treated to be adhesive, has been treated to adhere to the pharmacologically acceptable carrier, or has been treated to adhere to the active agent.

48. The floss of claim 41, wherein each adjacent drop or patch comprises a dye or indicia that distinguishes between adjacent deposit.

49. The floss of claim 41, wherein the floss is not dipped into the one or more nutrients, the pharmacologically acceptable carrier, or both.

50. The floss of claim 41, wherein the one or more nutrients are selected from iron, phosphorous, zinc, thiamine, riboflavin, niacin, vitamin B6, folate, vitamin, B12, pantothenic acid, biotin, boron, choline, chromium, copper, manganese, selenium, molybdenum, iodine, chloride, coenzyme Q10 (CoQ10), vitamin A, calcium, potassium, magnesium, vitamin E, vitamin C, a carotenoid, vitamin D, or vitamin K.

51. The floss of claim 41, wherein the floss has a thickness less than 5 mm, preferably less than 3 mm, preferably less than 1 mm, or preferably 35 to 175 microns.

52. The floss of claim 41, wherein the floss comprises natural or synthetic polymers, organic materials, metals, inorganic materials or combinations thereof.

53. The floss of claim 41, wherein the floss comprises a mucoadhesive layer or a hydrophobic layer or a hydrophilic layer or a combination.

54. The floss of claim 41, wherein the floss comprises a microporous structure allowing diffusion of antigen to gingival crevice.

55. The floss of claim 41, wherein the one or more nutrients are delivered to the junctional epithelium in a range from picograms to milligrams.

56. The floss of claim 41, wherein the one or more nutrients provide 10%, 20%, 30%, 40%, 50%, 60%, 70%, 80%, 90% or 100% of the daily dietary requirement by flossing 1, 2 or 3 times a day.

57. The floss of claim 41, wherein delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more before the subject eats food, drinks liquid, or brushing of teeth.

58. The floss of claim 41, wherein delivery of the one or more nutrients to a crevicular epithelium, a junctional epithelium, or combinations thereof is 0 hr, 0.1 hr, 0.2 hr, 0.3 hr, 0.4 hr, 0.5 hr, 0.6 hr, 0.7 hr, 0.8 hr, 0.9 hr, 1 hr, 2 hr, 3 hr, 4 hr, 5 hr, 6 hr, 7 hr, 8 hr or more after the subject eats food, drinks liquid, or brushing of teeth.

59. The floss of claim 41, wherein a viscosity of the deposit is 0.01 centipoise (cp), 1 cp, 10 cp, 100 cp, 1000 cp, 10000 cp, 100000 cp, 200000 cp, 300000 cp, 500000 cp, 1000000, or 100000000 cp.
